(19) United States
(12) Patent Application Publication
(10) Pub. No.: US 2015/0066246 A1
(43) Pub. Date: Mar. 5, 2015

(54) MAKING A USER'S INFORMATION AVAILABLE IN A VEHICLE

(71) Applicant: U-ME HOLDINGS LLC, CARTHAGE, MO (US)

(72) Inventor: Derek P. Martin, Carthage, MO (US)

(73) Assignee: U-ME HOLDINGS LLC, CARTHAGE, MO (US)

(21) Appl. No.: 14/153,630

(22) Filed: Jan. 13, 2014

Related U.S. Application Data
(63) Continuation-in-part of application No. 14/016,038, filed on Aug. 30, 2013.

(51) Int. Cl. H04L 29/08; B60R 16/037; B60W 50/00

(52) U.S. Cl. CPC H04L 67/306; B60W 50/0098; B60R 16/037; B60W 2050/0077
USPC 701/2

(57) ABSTRACT

A cloud-based computer system changes the modern paradigm from being device-centric to being person-centric. The system makes all user data, settings, and licensed content for a user available in the cloud. The user's information may be made available in a vehicle. The system includes a conversion mechanism that can convert information intended for one device type to a different device type. Thus, a user driving a Chevrolet can store the settings for the Chevrolet, which can then be converted to equivalent settings for any other vehicle, including vehicles from different manufacturers.

### BACKGROUND

1. Technical Field

This disclosure generally relates to computer systems, and more specifically relates to making a user's information available in a vehicle.

2. Background Art

Modern technology has greatly simplified many aspects of our lives. For example, the Internet has made vast amounts of information available at the click of a mouse. Smart phones allow not only making phone calls, but also provide a mobile computing platform by providing the ability to run apps, view e-mail, and access many different types of information, including calendar, contacts, etc.

Some cloud-based services allow storing data in the cloud, and providing access to that data from any device that has Internet access. Dropbox is an example of a cloud-based file service. A subscriber to Dropbox defines a file folder that is synchronized to the cloud, then all data written to the file folder will be automatically stored in the cloud, making that data automatically available to the user via any device that has an Internet connection. While services like Dropbox are very useful, they have their drawbacks. For example, a Dropbox user must remember to store data in a Dropbox folder or sub-folder. Many different software applications have default settings that save files to a folder that may not be a Dropbox folder. The user must know to change the default folder settings to a Dropbox folder if the data is to be available via Dropbox. But many users lack the knowledge or sophistication to realize all the changes that need to be made to a computer to assure all of the user's data is stored to Dropbox. As a result, if the user's hard drive crashes and data is not recoverable from the hard drive, the user may discover some of their data was not stored to a Dropbox folder or sub-folder, resulting in loss of that data when the hard drive crashed.

The evolution of modern technology has resulted in a world that is “device-centric.” This means each device must be configured to a user's needs. If a user owns a smart phone, tablet computer, and laptop computer, the user must take the time to configure each of these devices to his or her liking. This effort represents a significant investment of time for the user. For example, let's assume a user has been using the iPhone 4 for over a year, and decides to change to the Samsung Galaxy S4 phone. Depending on the vendor of the Samsung Galaxy S4 phone, the vendor may be able to transfer the phone contacts on the iPhone 4 to the new Samsung phone, but none of the apps or other data can be transferred. As a result, the decision to change to a new smart phone platform will require hours of time for the user to download apps and configure the new phone to his or her liking. The same problem exists when a user buys a new computer. The user must take the time to install all the software the user wants to use on the computer, and must take the time to configure the desired settings and preferences on the new computer. Again, this can be a very time-consuming proposition. It is not unusual for a user to spend many hours installing software and configuring a new computer system to his or her liking. For professionals who do not have the support of an IT department, taking the time to configure a new computer system either takes hours out of their work day, or takes hours of their personal time after work. In either case, the user loses hours of valuable time setting up a new computer system.

Not only must a user configure each of his or her devices, the configuration and capabilities of each device differ greatly. Apps installed on a smart phone are not made to run on a laptop or desktop computer. Software installed on a desktop or laptop computer are not made to run on smart phones. The result is the user must configure each device and install the software or apps to make the device as functional as the user needs it to be. This requires significant thought and expertise from the user to know how to configure each device.

Proliferation of technology in our modern live has extended to our vehicles. Many modern cars and trucks include power seats, power mirrors, and separate heat/air conditioning and settings for the driver and passenger sides. Vehicles are thus device-centric as well, requiring a user to configure a vehicle to the user's liking. Thus, when a user rents a car or purchases a new car, the user must take the time to configure the car to the user's liking.

### BRIEF SUMMARY

A cloud-based computer system changes the modern paradigm from being device-centric to being person-centric. The system makes all user data, settings, and licensed content for a user available in the cloud. The user's information may be made available in a vehicle. The system includes a conversion mechanism that can convert information intended for one device type to a different device type. Thus, a user driving a Chevrolet can store the settings for the Chevrolet, which can then be converted to equivalent settings for any other vehicle, including vehicles from different manufacturers.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is block diagram showing the Universal Me (U-Me) system;

FIG. 2 is block diagram showing additional details of the U-Me system;

FIG. 3 is block diagram showing a computer system that runs the U-Me system;

FIG. 4 is a block diagram showing how a user using a physical device can access information in the U-Me system;

FIG. 5 is a block diagram showing various features of the U-Me system;

FIG. 6 is a block diagram showing examples of user data;

FIG. 7 is a block diagram showing examples of user licensed content;

FIG. 8 is a block diagram showing examples of user settings;

FIG. 9 is a block diagram showing examples of universal templates;

FIG. 10 is a block diagram showing examples of device-specific templates;

FIG. 11 is a block diagram showing examples of phone templates;

FIG. 12 is a block diagram showing examples of tablet templates;

FIG. 13 is a block diagram showing examples of laptop templates;

FIG. 14 is a block diagram showing examples of desktop templates;

FIG. 15 is a block diagram showing examples of television templates;

FIG. 16 is a block diagram showing examples of software templates;

FIG. 17 is a block diagram showing examples of vehicle templates;

FIG. 18 is a block diagram showing examples of home automation templates;

FIG. 19 is a block diagram showing examples of gaming system templates;

FIG. 20 is a block diagram showing examples of audio system templates;

FIG. 21 is a block diagram showing examples of security system templates;

FIG. 22 is a block diagram showing examples of device interfaces;

FIG. 23 is a block diagram of a universal user interface;

FIG. 24 is a flow diagram of a method for programming a physical device with settings from the U-Me system;

FIG. 25 is a flow diagram of a first suitable method for performing step 2410 in FIG. 24 using a mapping between two physical devices;

FIG. 26 is a block diagram showing the generation of settings for Device2 from settings for Device 1 as shown in the flow diagram in FIG. 25;

FIG. 27 is a block diagram of a second suitable method for performing step 2410 in FIG. 24 using a universal template;

FIG. 28 is a block diagram showing the generation of settings for Device2 from a universal template as shown in the flow diagram in FIG. 27;

FIG. 29 is a block diagram of a third suitable method for performing step 2410 in FIG. 24 using settings from a first device and a universal template;

FIG. 30 is a block diagram showing the generation of settings for Device2 as shown in the flow diagram in FIG. 29;

FIG. 31 is a flow diagram of a method for generating settings in a universal vehicle template based on settings from a vehicle;

FIG. 32 shows examples of items that could be included in a universal vehicle template;

FIG. 33 is a flow diagram of a method for downloading user settings to a car from the user's U-Me account;

FIG. 34 is a representation of a vehicle seat with respect to the vehicle floor, the vehicle accelerator pedal, and the vehicle steering wheel;

FIG. 35 is a block diagram of a system for using a phone hands-free in a prior art vehicle;

FIG. 36 is a block diagram of a system for using a phone hands-free and also for accessing information in the vehicle's engine system;

FIG. 37 is a flow diagram of a method for prompting a user regarding scheduled maintenance for a vehicle;

FIG. 38 is a flow diagram of a method for providing shop bids to a user for scheduled maintenance;

FIG. 39 is a flow diagram of a method for notifying users of the U-Me system of manufacturer recalls and service actions for the manufacturer's vehicles;

FIG. 40 is a flow diagram of a method for providing vehicle service reminders to a user;

FIG. 41 is a flow diagram of a method for prompting the user when engine warning information is sent to the user's U-Me account; and

FIG. 42 is a flow diagram of a method for converting user settings from a first vehicle to corresponding user settings for a second vehicle that are used to configure the second vehicle.

### DETAILED DESCRIPTION

The evolution of technology has resulted in a device-centric world. Early desktop computer systems allowed a user to define certain settings or preferences that defined how the computer system functioned. This trend has continued to our modern times. Each computer system allows installing software according to the user's needs, and allows setting numerous settings or preferences that define how the computer system functions. A user who buys a new computer system typically must spend many hours installing software and setting user preferences and settings to get the computer system to a state where it is usable according to the user's needs.

The same device-centric approach has been used with cell phones, and now with smart phones. When a user purchases a new phone, the user typically must spend many hours installing apps and setting the appropriate preferences and settings so the smart phone will perform the functions the user desires. Some phone vendors provide a service that can transfer a person's contacts from their old phone to the new phone, and some provide a backup service for those contacts should the person lose or damage their phone. This backup service, however, typically backs up only the contacts, and does not back up apps or settings on the phone. Thus, even with the backup service, when a user gets a new phone, the user still spends hours downloading and installing apps, ringtones, etc. and setting all the system settings to configure the phone to the user's liking.

While many aspects of modern life have been simplified through the use of technology, other aspects have yet to take advantage of technology in a significant way. For example, let's assume a person is watching television (TV), and the TV has a failure that causes the TV to quit working. The user may then try to remember where she bought the TV, when she bought the TV, and whether the TV is still under warranty. The user must typically then locate a stack or file of paper receipts, then go through the stack or file hoping to find the paper receipt for the TV. Even when the user is able to locate the paper receipt, the receipt itself may not indicate the warranty information for the TV. She may have to search for the hard copy documentation she received with the TV. In the alternative, she could contact the store or the manufacturer to determine the warranty for the TV. And when the TV is under warranty, the user will have to make a photocopy of the receipt and send the copy of the receipt with the TV when the TV is returned for warranty service. This system of paper receipts is grossly inefficient, and does not benefit from technology available today.

One aspect of modern life that has been greatly simplified through the use of technology is how music is purchased and used. Apple's iPod was a revolutionary device that allowed storing a large number of songs, which the user may listen to at his or her convenience. To satisfy concerns in the music industry regarding the ease of pirating (performing illegal copying) of digital music files, Apple developed the iTunes software application that allows a user to purchase music, which is stored on the user's computer system in their iTunes account. This music may be copied from the computer system to a suitable Apple device, such as an iPod or iPad. However, music from an iPod or iPad cannot be copied to the user's computer because this would make illegal copying of music very easy. Thus, all of a user's music is stored in the user's computer system in their iTunes software. So what happens when the user's hard drive crashes? Recovering the music in an iTunes account that was on a hard drive that crashed is not an easy process. This is because the iTunes account is tied to the computer system on which iTunes is installed. This shows that iTunes is device-centric as well, which means if the device that hosts iTunes crashes, the music that was stored on the device is difficult to recover.

Another aspect of our modern life that has not fully taken advantage of modern technology is data storage and retrieval. As referenced in the Background section above, Dropbox is an online service that allows storing information to the cloud. However, Dropbox is based on the folder/subfolder (or directory/subdirectory) paradigm. Thus, when using Dropbox, the user must remember to store the data in a Dropbox folder or subfolder, and then must also store the data in a location and use a file name the user is likely to remember. Relying on the memory of a user to remember where the user stored something on a computer system is very inefficient and error-prone. Many users have experienced storing a file to their computer system, then having to search many files across many directories in an attempt to locate the file they stored. Database systems provide very structured ways of storing information, which results in supporting very powerful ways of retrieving information in the database via queries. However, these powerful database tools for storing and retrieving information have not been employed in helping most users to store and retrieve information on their computer systems or smart phones.

Photography is an area that has greatly benefitted from modern technology. Digital cameras and cell phones allow capturing very high-resolution photographs and video in digital form that can be easily stored to an electronic device. While photography itself has been revolutionized by technology, the technology for storing and retrieving photographs has lagged far behind. Many people who have used digital cameras for years have many directories or folders on a computer system that contain thousands of digital photos and videos. When a person uses a digital camera or cell phone to take a photo, the device typically names the photo with a cryptic name that includes a number that is sequential. For example, a Nikon camera may name a photo file with a name such as “DSC_{—}0012.jpg.”. The digital file for the next photo is the next number in sequence, such as DSC_{—}0013.jpg. Once the photo files are transferred to a computer and are deleted on the digital camera or cell phone, the digital camera or cell phone may reuse file names that were used previously. To avoid overwriting existing photos, many users choose to create a new directory or folder each time photos are downloaded from a camera or cell phone. This results in two significant problems. First, the file name for a photo may be shared by multiple photos in multiple directories. Second, the names of files give the user no information regarding the photo. Thus, to locate a particular photo of interest, the user may have to navigate a large number of directories, searching thumbnails of the photos in each directory to locate the desired photo. This is grossly inefficient and relies on the memory of the user to locate a desired photo. A user can more efficiently locate photos if the user takes the time to carefully name directories or folders and also takes the time to carefully name individual photo files. But this is very time-consuming, and most users don't take the time needed to name folders and photo files in a way that would make retrieval of the photos easier. Most people who take digital photos have thousands of photos that have cryptic names in dozens or hundreds of different directories or folders that may also have cryptic names. The result is that finding a particular photo may be very difficult.

While there are programs that allow organizing digital photos, they have not gained widespread acceptance due to their expense and the time required and difficulty for a user to organize their photos using these programs. As a result, these programs have done little to address the widespread problem of most users having thousands of digital photos that are stored using cryptic names in many different directories or folders, making retrieval of photographs difficult.

The disclosure herein presents a paradigm shift, from the device-centric world we live in today, to a person-centric world. This shift gives rise to many different opportunities that are not available in the world we live in today. A system called Universal Me (U-Me) disclosed herein is a cloud-based system that is person-centric. The U-Me system makes a user's data, licensed content and settings available in the cloud to any suitable device that user may choose to use.

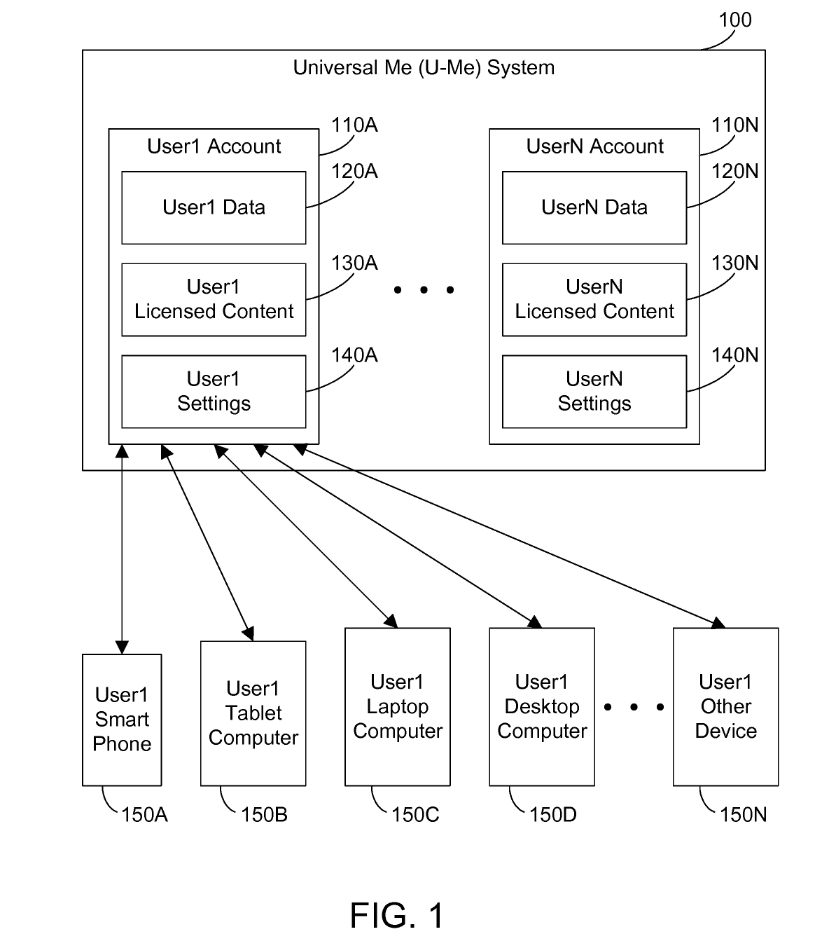

Referring to FIG. 1, the Universal Me (U-Me) system 100 includes multiple user accounts 110, shown in FIG. 1 as 110A, . . . , 110N. Each user account includes data, licensed content, and settings that correspond to the user. Thus, User1 account 110A includes corresponding data 120A, licensed content 130A, and settings 140A. In similar fashion, UserN account 110N includes corresponding data 120N, licensed content 130N, and settings 140N. Any or all of the user's data, licensed content and settings may be made available on any device 150 the user may use. Examples of suitable devices are shown in FIG. 1 to include a smart phone 150A, a tablet computer 150B, a laptop computer 150C, a desktop computer 150D, and other device 150N. The devices shown in FIG. 1 are examples of suitable devices the user could use to access any of the data, licensed content, or settings in the user's account. The disclosure and claims herein expressly extend to using any type of device to access the user's data, licensed content, or settings, whether the device is currently known or developed in the future.

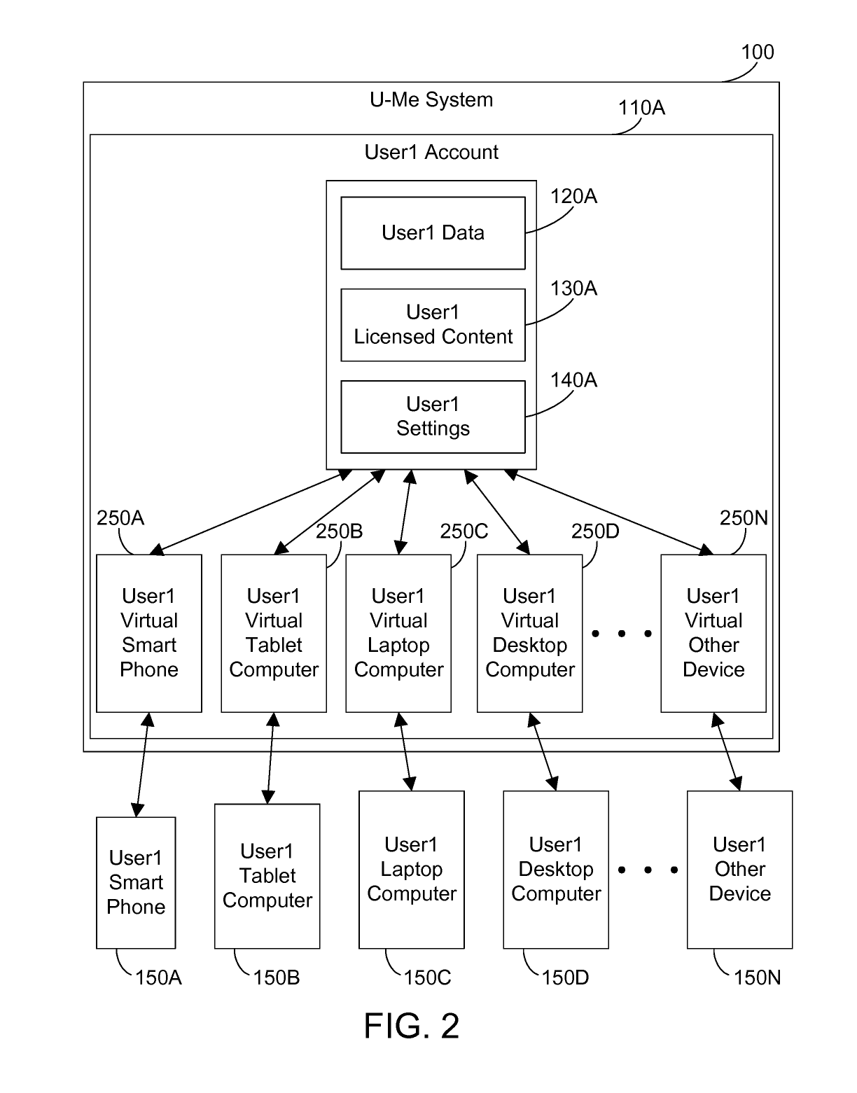

The U-Me system 100 may include virtual devices in a user's account. Referring to FIG. 2, the User1 account 110A is shown to include a virtual smart phone 250A that corresponds to the physical smart phone 150A; a virtual tablet computer 250B that corresponds to the physical tablet computer 150B; a virtual laptop computer 250C that corresponds to the physical laptop computer 150C; a virtual desktop computer 250D that corresponds to a physical desktop computer 150D; and a virtual other device 250N that corresponds to a physical other device 150N. The virtual devices preferably include all information that makes a physical device function, including operating system software and settings, software applications (including apps) and their settings, and user settings. It may be impossible due to access limitations on the physical device to copy all the information that makes the physical device function. For example, the operating system may not allow for the operating system code to be copied. The virtual devices contain as much information as they are allowed to contain by the physical devices. In the most preferred implementation, the virtual devices contain all information that makes the physical devices function. In this scenario, if a user accidentally flushes his smart phone down the toilet, the user can purchase a new smart phone, and all the needed information to configure the new smart phone exactly as the old one is available in the virtual smart phone stored in the user's U-Me account. Once the user downloads a U-Me app on the new smart phone, the phone will connect to the user's U-Me account, authenticate the user, and the user will then have the option of configuring the new device exactly as the old device was configured using the information in the virtual smart phone in the user's U-Me account.

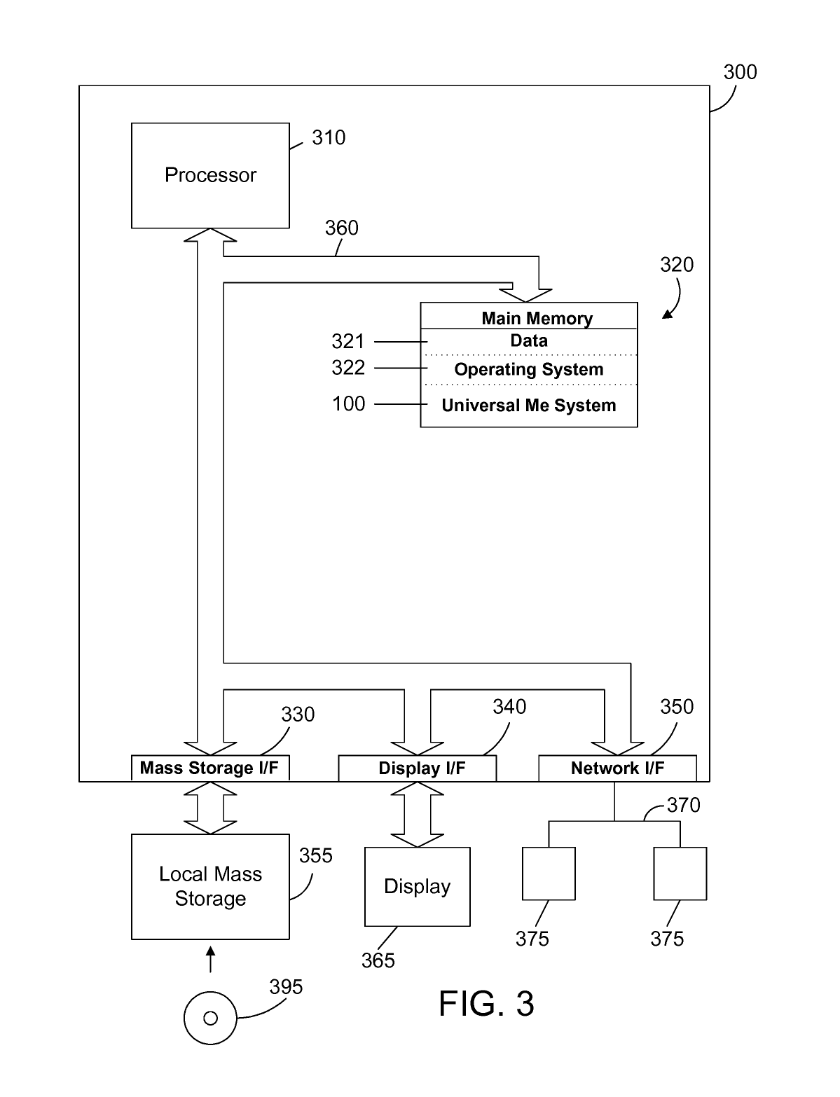

FIG. 2 in conjunction with FIG. 3 supports a computer-implemented method executing on at least one processor comprising the steps of storing user data corresponding to a first user, storing first user settings corresponding to the first user for a plurality of software applications, storing second user settings corresponding to the first user for a plurality of physical devices, and making the user data, the first user settings, and the second user settings available to the first user on a first device used by the first user.

There may be some software on a physical device that cannot be copied to the corresponding virtual device. When this is the case, the U-Me account will prompt the user with a list of things to do before the new physical device can be configured using the data in the virtual device. For example, if the user had just applied an operating system update and the new phone did not include that update, the user will be prompted to update the operating system before continuing. If an app installed on the old phone cannot be copied to the user's U-Me account, the U-Me app could prompt the user to install the app before the rest of the phone can be configured. The virtual device preferably contains as much information as possible for configuring the new device, but when information is missing, the U-Me system prompts the user to perform certain tasks as prerequisites. Once the tasks have been performed by the user, the U-Me system can take over and configure the phone using the information stored in the corresponding virtual device.

Referring to FIG. 3, a computer system 300 is an example of one suitable computer system that could host the universal me system 100. Server computer system 300 is an IBM System i computer system. However, those skilled in the art will appreciate that the disclosure and claims herein apply equally to any computer system, regardless of whether the computer system is a complicated multi-user computing apparatus, a single user workstation, or an embedded control system. As shown in FIG. 3, computer system 300 comprises one or more processors 310, a main memory 320, a mass storage interface 330, a display interface 340, and a network interface 350. These system components are interconnected through the use of a system bus 360. Mass storage interface 330 is used to connect mass storage devices, such as local mass storage device 355, to computer system 300. One specific type of local mass storage device 355 is a readable and writable CD-RW drive, which may store data to and read data from a CD-RW 395.

Main memory 320 preferably contains data 321, an operating system 322, and the Universal Me System 100. Data 121 represents any data that serves as input to or output from any program in computer system 100. Operating system 322 is a multitasking operating system. The Universal Me System 100 is the cloud-based system described in detail in this specification. The Universal Me System 100 as shown in FIG. 3 is a software mechanism that provides all of the functionality of the U-Me system.

FIG. 3 in conjunction with FIG. 1 thus shows a computer system comprising at least one processor, a memory coupled to the at least one processor, user data residing in the memory corresponding to a first user, first user settings corresponding to the first user for a plurality of software applications residing in the memory, second user settings corresponding to the first user for a plurality of hardware devices, and a software mechanism executed by the at least one processor that makes the user data, the first user settings, and the second user settings available to the first user on a first device used by the first user.

Computer system 300 utilizes well known virtual addressing mechanisms that allow the programs of computer system 300 to behave as if they only have access to a large, contiguous address space instead of access to multiple, smaller storage entities such as main memory 320 and local mass storage device 355. Therefore, while data 321, operating system 322, and Universal Me System 100 are shown to reside in main memory 320, those skilled in the art will recognize that these items are not necessarily all completely contained in main memory 320 at the same time. It should also be noted that the term “memory” is used herein generically to refer to the entire virtual memory of computer system 300, and may include the virtual memory of other computer systems coupled to computer system 300.

Processor 310 may be constructed from one or more microprocessors and/or integrated circuits. Processor 310 executes program instructions stored in main memory 320. Main memory 320 stores programs and data that processor 310 may access. When computer system 300 starts up, processor 310 initially executes the program instructions that make up the operating system 322. Processor 310 also executes the Universal Me System 100.

Although computer system 300 is shown to contain only a single processor and a single system bus, those skilled in the art will appreciate that the Universal Me system may be practiced using a computer system that has multiple processors and/or multiple buses. In addition, the interfaces that are used preferably each include separate, fully programmed microprocessors that are used to off-load compute-intensive processing from processor 310. However, those skilled in the art will appreciate that these functions may be performed using I/O adapters as well.

Display interface 340 is used to directly connect one or more displays 365 to computer system 300. These displays 365, which may be non-intelligent (i.e., dumb) terminals or fully programmable workstations, are used to provide system administrators and users the ability to communicate with computer system 300. Note, however, that while display interface 340 is provided to support communication with one or more displays 365, computer system 300 does not necessarily require a display 365, because all needed interaction with users and other processes may occur via network interface 350.

Network interface 350 is used to connect computer system 300 to other computer systems or workstations 375 via network 370. Network interface 350 broadly represents any suitable way to interconnect electronic devices, regardless of whether the network 370 comprises present-day analog and/or digital techniques or via some networking mechanism of the future. Network interface 350 preferably includes a combination of hardware and software that allow communicating on the network 370. Software in the network interface 350 preferably includes a communication manager that manages communication with other computer systems 375 via network 370 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 350.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

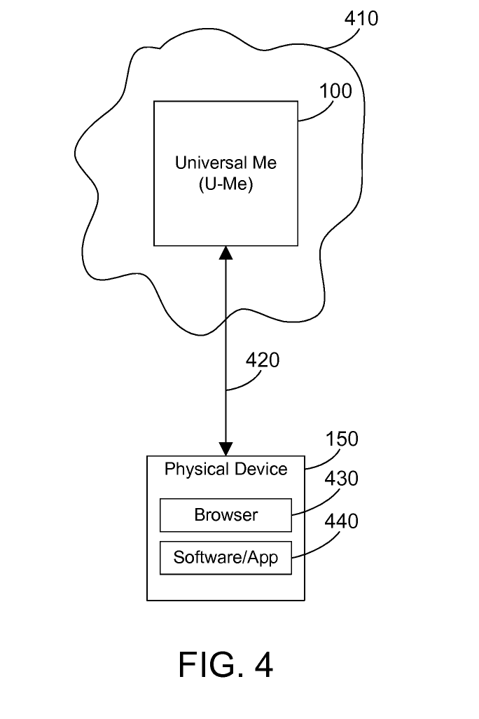

FIG. 4 shows another view of a configuration for running the U-Me system 100. The U-Me system 100 runs in a cloud, shown in FIG. 4 as cloud 410. A user connects to the U-Me system 100 using some physical device 150 that may include a browser 430 and/or software 440 (such as an application or app) that allows the user to interact with the U-Me system 100. Note the physical device 150 is connected to the U-Me system 100 by a network connection 420, which is representative of network 370 shown in FIG. 3, and which can include any suitable wired or wireless network or combination of networks. The network connection 420 in the most preferred implementation is an Internet connection, which makes the U-Me system available to any physical device that has Internet access. Note, however, other types of networks may be used, such as satellite networks and wireless networks. The disclosure and claims herein expressly extend to any suitable network or connection for connecting a physical device to the U-Me system 100.

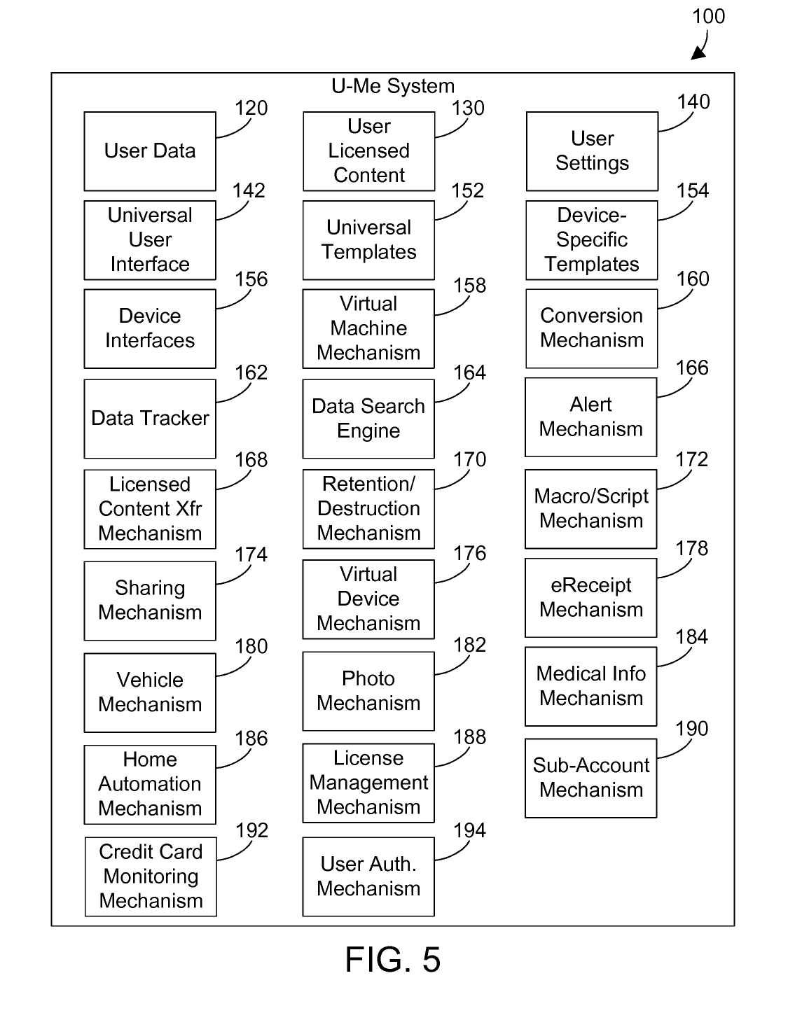

Various features of the U-Me system are represented in FIG. 5. U-Me system 100 includes user data 120, user licensed content 130, and user settings 140, as the specific examples in FIGS. 1 and 2 illustrate. U-Me system 100 further includes a universal user interface 142, universal templates 152, device-specific templates 154, device interfaces 156, a virtual machine mechanism 158, a conversion mechanism 160, a data tracker 162, a data search engine 164, an alert mechanism 166, a licensed content transfer mechanism 168, a retention/destruction mechanism 170, a macro/script mechanism 172, a sharing mechanism 174, a virtual device mechanism 176, an eReceipt mechanism 178, a vehicle mechanism 180, a photo mechanism 182, a medical info mechanism 184, a home automation mechanism 186, a license management mechanism 188, a sub-account mechanism 190, a credit card monitoring mechanism 192, and a user authentication mechanism 194. Each of these features is discussed in more detail below. The virtual devices 150 in FIG. 2 are preferably created and maintained by the virtual device mechanism 176 in FIG. 5.

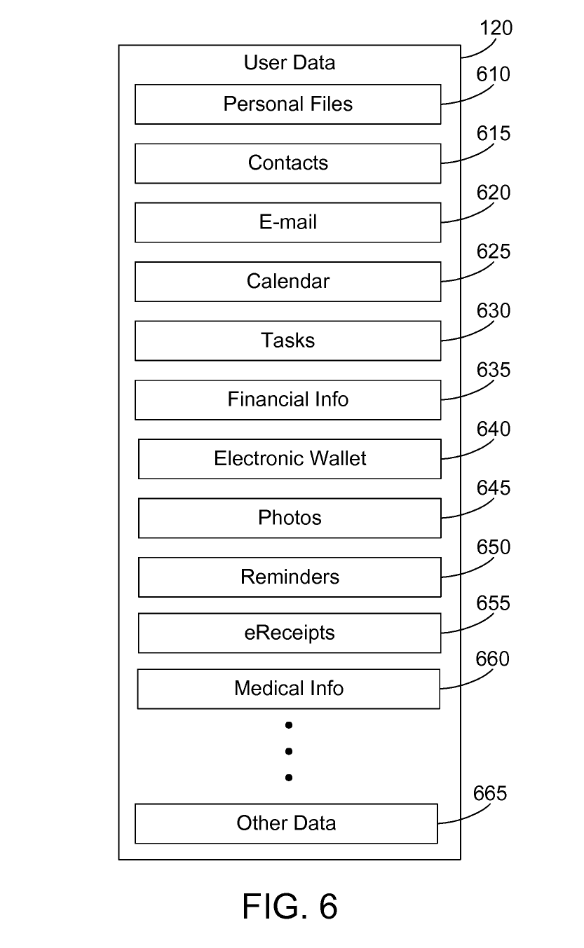

FIG. 6 shows some specific examples of user data 120 that could be stored in a user's U-Me account, including personal files 610, contacts 615, e-mail 620, calendar 625, tasks 630, financial info 635, an electronic wallet 640, photos 645, reminders 650, eReceipts 655, medical information 660, and other data 665. The user data shown in FIG. 6 are examples shown for the purpose of illustration. The disclosure and claims herein extend to any suitable data that can be generated by a user, generated for a user, or any other data relating in any way to the user, including data known today as well as data developed in the future.

Personal files 610 can include any files generated by the user, including word processor files, spreadsheet files, .pdf files, e-mail attachments, etc. Contacts 615 include information for a user's contacts, preferably including name, address, phone number(s), e-mail address, etc. E-mail 620 is e-mail for the user. E-mail 620 may include e-mail from a single e-mail account, or e-mail from multiple e-mail accounts. E-mail 620 may aggregate e-mails from different sources, or may separate e-mails from different sources into different categories or views. Calendar 625 includes an electronic calendar in any suitable form and format. Tasks 630 include tasks that a user may set and tasks set by the U-Me system. Financial info 635 can include any financial information relating to the user, including bank statements, tax returns, investment account information, etc. Electronic wallet 640 includes information for making electronic payments, including credit card and bank account information for the user. Google has a product for Android devices called Google Wallet. The electronic wallet 640 can include the features of known products such as Google Wallet, as well as other features not known in the art.

Photos 645 include electronic files for photographs and videos. While it is understood that a user may have videos that are separate from photographs, the term “photos” as used herein includes both photographs and videos for the sake of convenience in discussing the function of the U-Me system. Reminders 650 include any suitable reminders for the user, including reminders for events on the calendar 625, reminders for tasks 630, and reminders set by the U-Me system for other items or events. eReceipts 655 includes electronic receipts in the form of electronic files that may include warranty information and/or links that allow a user to make a warranty claim. Medical info 660 includes any suitable medical information relating to the user, including semi-private medical information, private medical information, and information provided by medical service providers, insurance companies, etc.

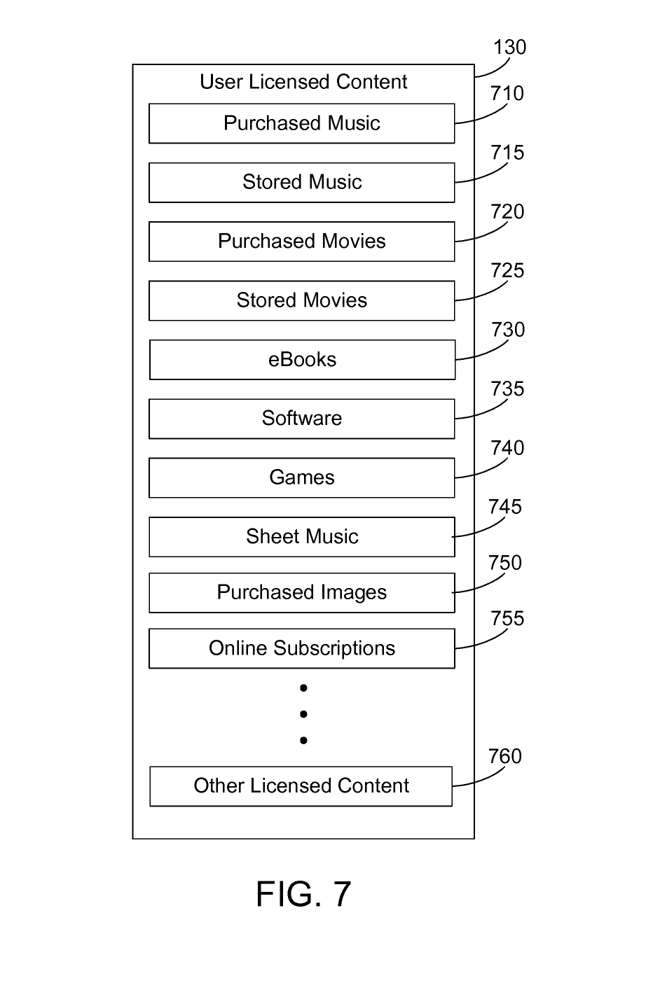

FIG. 7 shows some specific examples of user licensed content 130 that could be stored in a user's U-Me account, including purchased music 710, stored music 715, purchased movies 720, stored movies 725, eBooks 730, software 735, games 740, sheet music 745, purchased images 750, online subscriptions 755, and other licensed content 760. The user licensed content shown in FIG. 7 are examples shown for the purpose of illustration. The disclosure and claims herein extend to any suitable user licensed content, including user licensed content known today as well as user licensed content developed in the future.

Purchased music 710 includes music that was purchased from an online source. Note the purchased music 710 could include entire music files, or could include license information that authorizes the user to stream a music file on-demand. Stored music 715 includes music the user owns and which has been put into electronic format, such as music recorded (i.e., ripped) from a compact disc. Purchased movies 720 include movies that were purchased from an online source. Note the purchased movies 720 could include an entire movie file, or could include license information that authorizes the user to stream a movie on-demand. Stored movies 725 include movies the user owns and which have been put into electronic format, such as movies recorded from a digital video disc (DVD). eBooks 730 include books for the Apple iPad, books for the Kindle Fire, and books for the Barnes & Noble Nook. Of course, eBooks 730 could include books in any suitable electronic format.

Software 735 includes software licensed to the user and/or to the user's devices. In the most preferred implementation, software is licensed to the user and not to any particular device, which makes the software available to the user on any device capable of running the software. However, software 735 may also include software licensed to a user for use on only one device, as discussed in more detail below. Software 735 may include operating system software, software applications, apps, or any other software capable of running on any device. In addition, software 735 may include a backup of all software stored on all devices used by the user. Games 740 include any suitable electronic games, including games for computer systems and any suitable gaming system. Known gaming systems include Sony Playstation, Microsoft Xbox, Nintendo Wii, and others. Games 740 may include any games for any platform, whether currently known or developed in the future. Sheet music 745 includes sheet music that has been purchased by a user and is in electronic form. This may include sheet music files that are downloaded as well as hard copy sheet music that has been scanned. Some pianos now include an electronic display screen that is capable of displaying documents such as sheet music files. If a user owns such a piano, the user could access via the piano all of the user's stored sheet music 745 in the user's U-Me account. Purchased images 750 include any images purchased by the user, including clip art, pictures, etc. Online subscriptions 755 include content generated by the user on a subscription basis by any suitable provider. For example, if a user subscribes to Time magazine online, the online subscriptions 755 could include electronic copies of Time magazine.

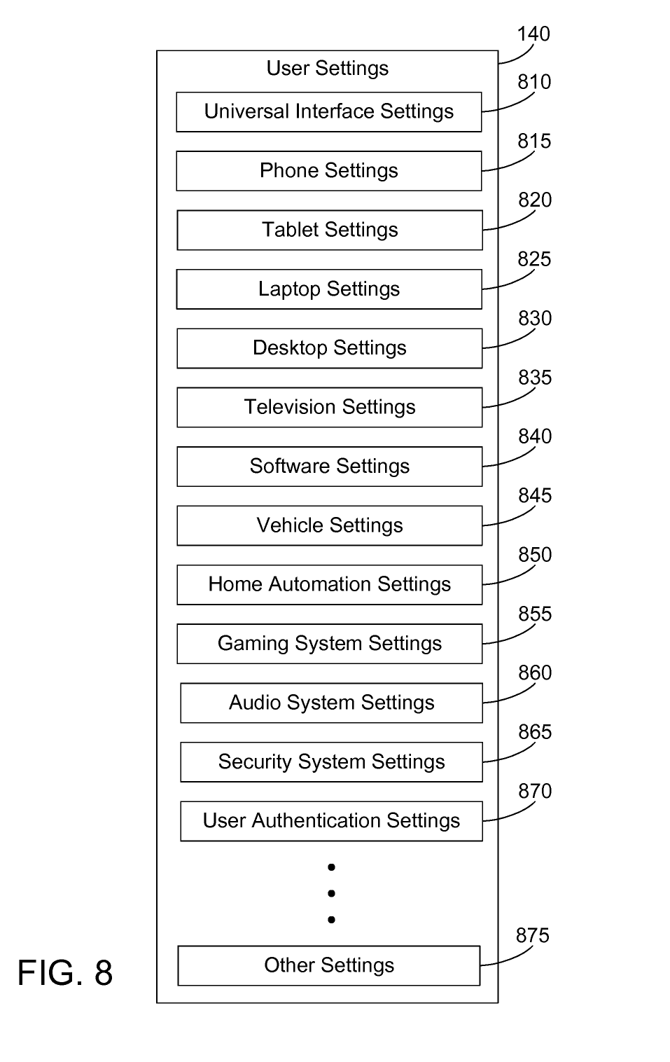

FIG. 8 shows some specific examples of user settings 140 that could be stored in a user's U-Me account, including universal interface settings 810, phone settings 815, tablet settings 820, laptop settings 825, desktop settings 830, television settings 835, software settings 840, vehicle settings 845, home automation settings 850, gaming system settings 855, audio system settings 860, security system settings 865, user authentication settings 870, and other settings 875. The user settings shown in FIG. 8 are examples shown for the purpose of illustration. The software settings 840, which include user settings for software applications, include user preferences for each software application. Note the term “software application” is used herein to broadly encompass any software the user can use, whether it is operating system software, an application for a desktop, an app for a phone, or any other type of software. User settings for physical devices include user settings for each physical device. The term “physical device” is used herein to broadly any tangible device, whether currently known or developed in the future, that includes any combination of hardware and software. The disclosure and claims herein extend to any suitable user settings, including user settings known today as well as user settings developed in the future.

Universal interface settings 810 include settings for a universal interface for the U-Me system that can be presented to a user on any suitable device, which allows the user to interact with the U-Me system using that device. Phone settings 815 include settings for the user's phone, such as a smart phone. Apple iPhone and Samsung Galaxy S4 are examples of known smart phones. Tablet settings 820 include settings for the user's tablet computer. Examples of known tablet computers include the Apple iPad, Amazon Kindle, Barnes & Noble Nook, Samsung Galaxy Tab, and many others. Laptop settings 825 are settings for a laptop computer. Desktop settings 830 are settings for a desktop computer. Television settings 835 are settings for any suitable television device. For example, television settings 835 could include settings for a television, for a cable set-top box, for a satellite digital video recorder (DVR), for a remote control, and for many other television devices. Software settings 840 include settings specific to software used by the user. Examples of software settings include the configuration of a customizable menu bar on a graphics program such as Microsoft Visio; bookmarks in Google Chrome or favorites in Internet Explorer; default file directory for a word processor such as Microsoft Word; etc. Software settings 840 may include any suitable settings for software that may be defined or configured by a user.

Vehicle settings 845 include user settings relating to a vehicle, including such things as position of seats, position of mirrors, position of the steering wheel, radio presets, heat/cool settings, music playlists, and video playlists. Home automation settings 850 include settings for a home automation system, and may include settings for appliances, heating/ventilation/air conditioning (HVAC), lights, security, home theater, etc. Gaming system settings 855 include settings relating to any gaming system. Audio system settings 860 include settings for any suitable audio system, including a vehicle audio system, a home theater system, a handheld audio player, etc. The security system settings 865 may include settings for any suitable security system. User authentication settings 870 include settings related to the user's authentication to the U-Me system.

The U-Me system makes a user's data, licensed content, and settings available to the user on any device the user desires to use. This is a significant advantage for many reasons. First of all, even for people who are comfortable with technology, getting a device configured exactly as the user wants is time-consuming and often requires research to figure out how to configure the device. For example, let's assume a user installs the Google Chrome browser on a desktop computer. When the user downloads a file using Google Chrome, the downloaded file appears as a clickable icon on the lower left of the Google Chrome display. To open the file, the user clicks on the icon. Let's assume the user wants to always open .pdf files after they are downloaded. Because the user does not know how to configure Chrome to do this, the user does a quick search, and discovers that Chrome can be configured to always open .pdf files after they are downloaded by clicking on a down arrow next to the downloaded .pdf file icon, which brings up a pop-up menu, then selecting “Always open files of this type.” This configures Google Chrome to always open .pdf files after they are downloaded. However, the user cannot be expected to remember this small tidbit of knowledge. If the user made this setting change to Google Chrome when the desktop computer was new, and two years passes when the user gets a new desktop computer, it is highly unlikely the user will remember how to configure Google Chrome to automatically open .pdf files after they are downloaded. In any modern device, there are dozens or perhaps hundreds of such user settings. By storing these user settings in the user's U-Me account, the user will not have to remember each and every setting the user makes in each and every device. The same is true for configuring a smart phone. Often users have to search online to figure out how to do certain things, such as setting different ringtones for different contacts. In today's world, such settings are lost when a user changes to a different phone, which requires the user repeat the learning process to configure the new phone. With the U-Me system disclosed herein, all of the user's settings are saved to the user's U-Me account, allowing a new device to be easily configured using the stored user settings.

While the previous paragraph discusses an example of a user setting in Google Chrome, similar concepts apply to user data and user licensed content. There is currently no known way to make all of a user's data, licensed content, and settings available in the cloud so this information is available to the user on any device or system the user decides to use. The Universal Me system solves this problem. The system is called Universal Me because it “allows me to be me, anywhere” for each user. Thus, a user on vacation on Italy could find an Internet café, use a computer in the Internet café to access the user's universal interface to the U-Me system, and would then have access to all of the user's data, licensed content, and settings. Similarly, the user could borrow an iPad from a friend, and have access to all the user's data, licensed content, and settings. The power and flexibility of the U-Me system leads to its usage in many different scenarios, several of which are described in detail below.

While many different categories of user settings are shown in FIG. 8, these are shown by way of example. A benefit of the U-Me system is that a user only has to configure a device once, and the configuration for that device is stored in the user's U-Me account. Replacing a device that is lost, stolen, or broken is a simple matter of buying a new similar device, then following the instructions provided by the U-Me system to configure the new device to be identical to the old device. In the most preferred implementation, the U-Me system will back up all user data, licensed content, and settings related to the device to the user's U-Me account, which will allow the U-Me system to configure the new device automatically with minimal input from the user. However, features of the devices themselves may prevent copying all the relevant data, licensed content and settings to the user's U-Me account. When this is the case, the U-Me system will provide instructions to the user regarding what steps the user needs to take before the U-Me system can configure the device with the information stored in the user's U-Me account.

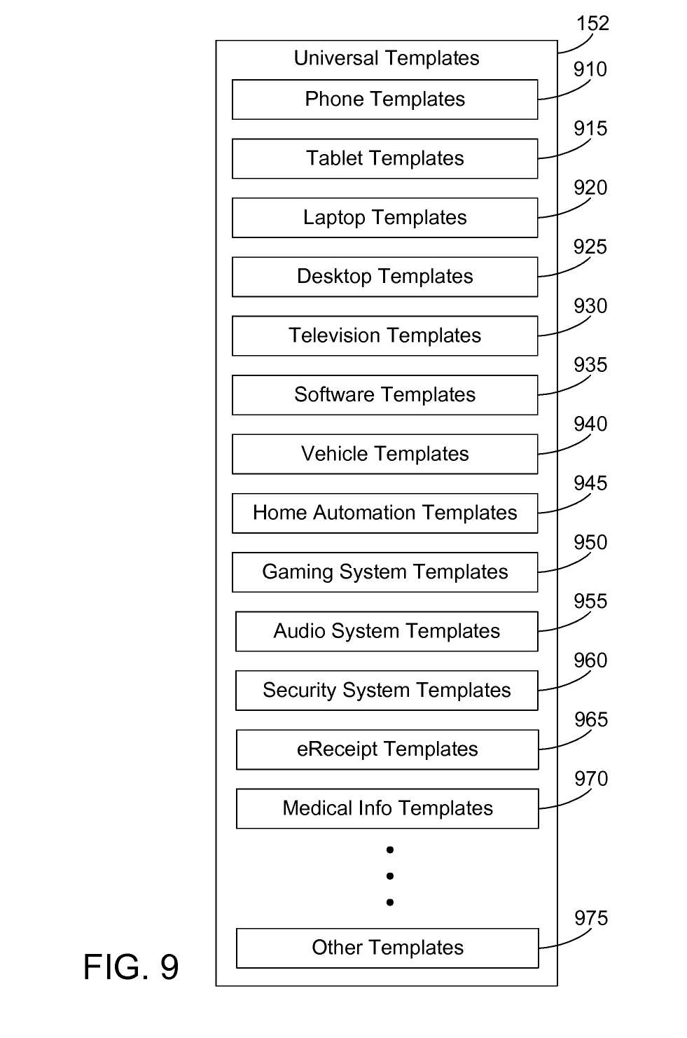

The U-Me system could use various templates that define settings for different physical devices. Referring to FIG. 9, universal templates 152 include phone templates 910, tablet templates 915, laptop templates 920, desktop templates 925, television templates 930, software templates 935, vehicle templates 940, home automation templates 945, gaming system templates 950, audio system templates 955, security system templates 960, eReceipt templates 965, medical information templates 970, and other templates 975. The universal templates shown in FIG. 9 are examples shown for the purpose of illustration. The disclosure and claims herein extend to any suitable universal templates, including universal templates related to devices known today as well as universal templates related to devices developed in the future.

The various universal templates in FIG. 9 include categories of devices that may include user settings. One of the benefits of the U-Me system is the ability for a user to store settings for any device or type of device that requires configuration by the user. This allows a user to spend time once to configure a device or type of device, and the stored settings in the user's U-Me account will allow automatically configuring identical or similar devices. The U-Me system expressly extends to storing any suitable user data and/or user licensed content and/or user settings for any suitable device in a user's U-Me account.

The universal templates 152 provide a platform-independent way of defining settings for a particular type of device. Thus, a universal phone template may be defined by a user using the U-Me system without regard to which particular phone the user currently has or plans to acquire. Because the universal templates are platform-independent, they may include settings that do not directly map to a specific physical device. Note, however, the universal templates may include information uploaded from one or more physical devices. The universal template can thus become a superset of user data, user licensed content, and user settings for multiple devices. The universal templates can also include settings that do not correspond to a particular setting on a particular device.

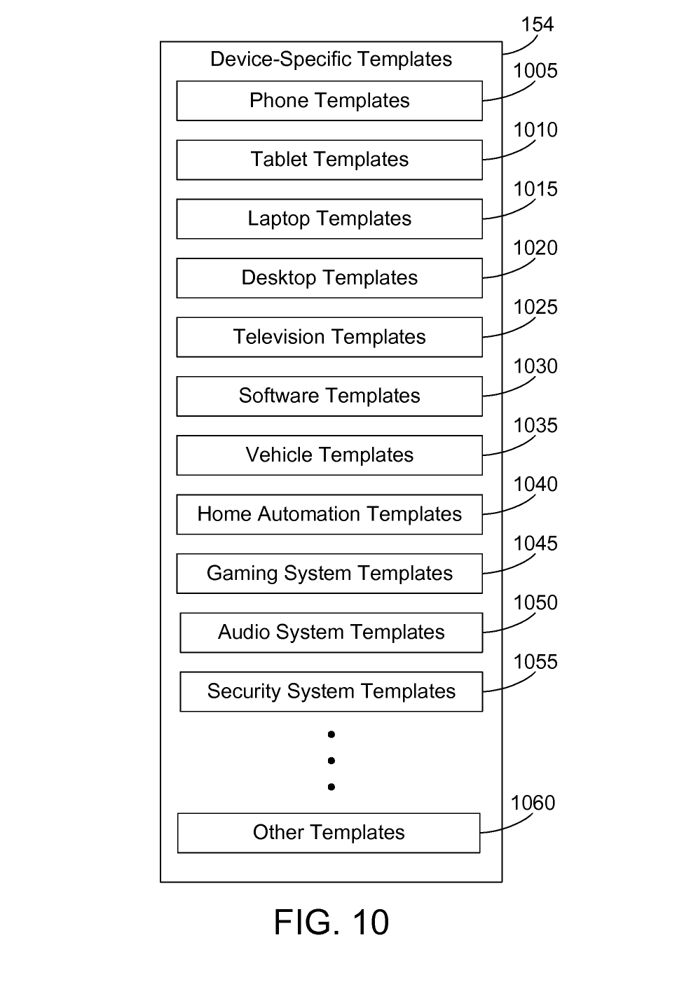

Referring to FIG. 10, device-specific templates 154 include phone templates 1005, tablet templates 1010, laptop templates 1015, desktop templates 1020, television templates 1025, software templates 1030, vehicle templates 1035, home automation templates 1040, gaming system templates 1045, audio system templates 1050, security system templates 1055, and other templates 1060. The device-specific templates shown in FIG. 10 are examples shown for the purpose of illustration. The disclosure and claims herein extend to any suitable device-specific templates, including device-specific templates for devices known today as well as device-specific templates for devices developed in the future.

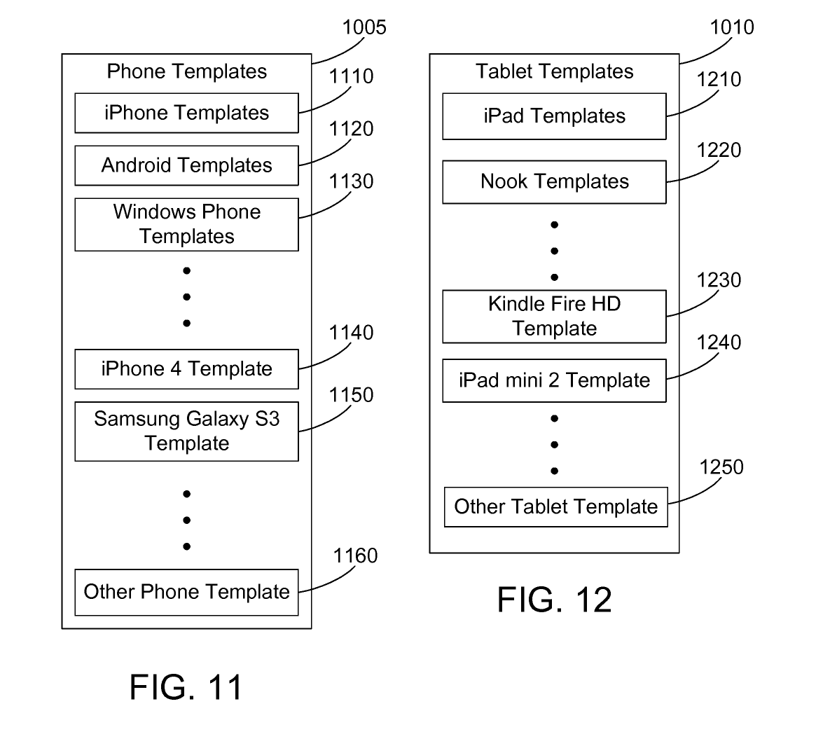

The device-specific templates 154 provide platform-dependent templates. Thus, the user data, user licensed content, and user settings represented in a device-specific template includes specific items on a specific device or device type. The device-specific templates 154 may also include mapping information to map settings in a physical device to settings in a universal template. FIGS. 11-21 are related to device specific templates 154. Referring to FIG. 11, phone templates 1005 may include iPhone templates 1110, Android templates 1120 and Windows phone templates 1130, which represent different phone types. Phone templates 1005 may also include templates for a specific phone, such as iPhone 4 template 1140 and Samsung Galaxy S3 template 1150, as well as one or more other phone templates 1160 that may be for a phone type or for a specific phone.

Tablet templates 1010 are shown in FIG. 12 to include iPad templates 1210 and Nook templates 1220, which represent different tablet platforms. Tablet templates 1010 may also include templates for a specific tablet, such as a Kindle Fire HD template 1230 and an iPad mini 2 template 1240, as well as one or more other tablet templates 1250 that may be for a tablet type or for a specific tablet.

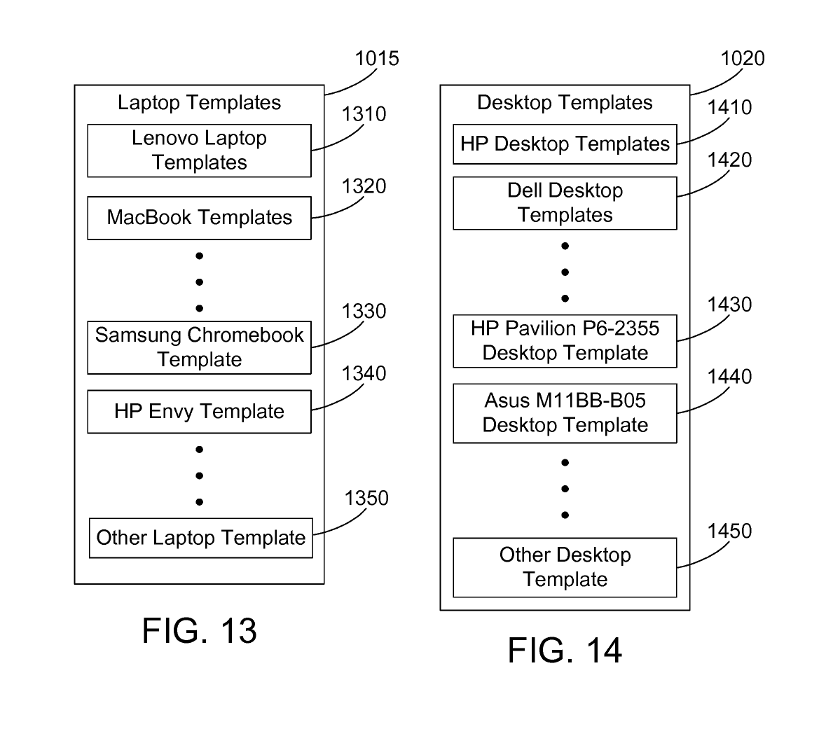

Laptop templates 1015 are shown in FIG. 13 to include Lenovo laptop templates 1310 and MacBook templates 1320, which represent different laptop computer types. Laptop templates 1015 may also include templates for a specific laptop, such as a Samsung Chromebook template 1330 and an HP Envy template 1340, as well as one or more other laptop templates 1350 that may be for a laptop type or for a specific laptop.

Desktop templates 1020 are shown in FIG. 14 to include HP desktop templates 1410 and Dell desktop templates 1420, which represent different laptop computer types. Desktop templates 1020 may also include templates for a specific desktop computer, such as an HP Pavilion PS-2355 desktop template 1430 and an Asus M11BB-B05 desktop template 1440, as well as one or more other desktop templates 1450 that may be for a desktop type or for a specific desktop computer.

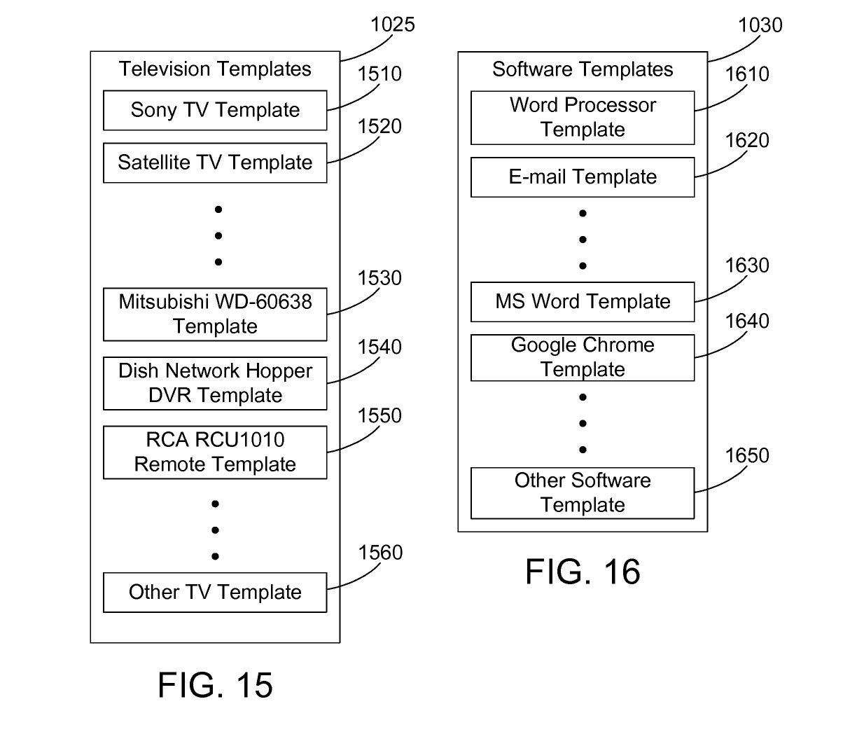

Television templates 1025 are shown in FIG. 15 to include a Sony TV template 1510 and a satellite TV template 1520, which represent different types of television devices. Television templates 1025 may also include templates for a specific television device, such as a Mitsubishi WD-60638 template 1530, a Dish Network Hopper DVR template 1540, and an RCA RCU1010 remote template 1540, as well as one or more other television device templates 1560 that may be for a television device type or for a specific television-related device.

Software templates 1030 are shown in FIG. 16 to include a word processor template 1610 and an e-mail template 1620, which represent different types of software. Software templates 1030 may also include templates for specific software, such as a Microsoft Word template 1630 and a Google Chrome template 1640, as well as one or more other software templates 1650 that may be for a type of software or for specific software.

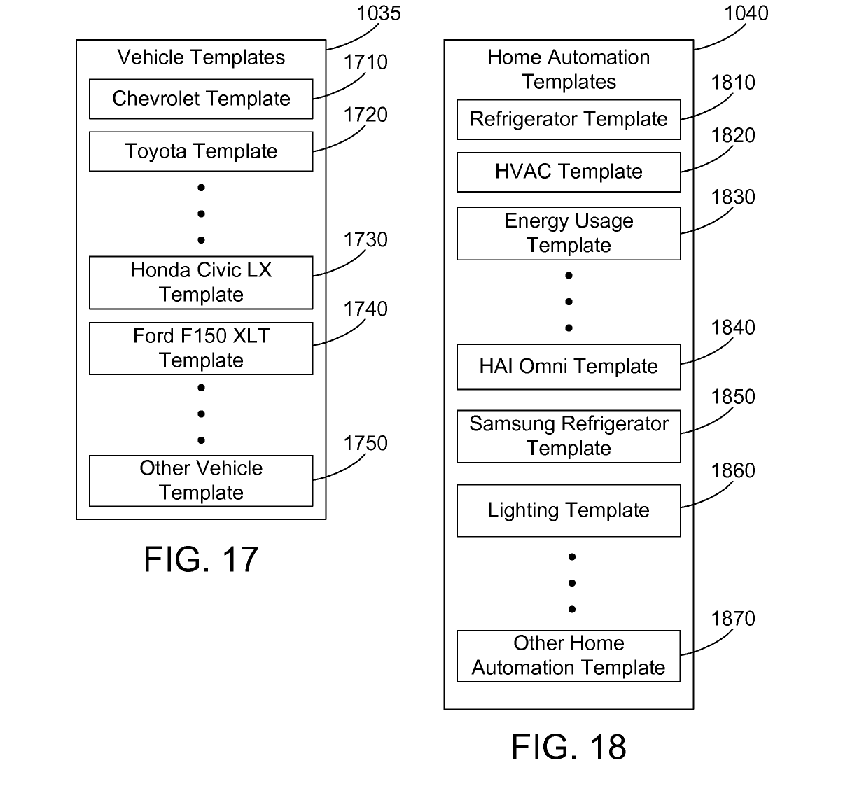

Vehicle templates 1035 are shown in FIG. 17 to include a Chevrolet template 1710 and a Toyota template 1720, which represent different types of vehicles. Vehicle templates 1035 may also include templates for specific vehicles, such as a Honda Civic LX template 1730 or a Ford F150 XLT template 1740, as well as one or more other vehicle templates 1750 that may be for a type of vehicle or for a specific vehicle. Note while the only vehicles shown in FIG. 17 are cars and a small truck, the vehicle templates 1035 could include templates for any type of vehicle, including cars, trucks, boats, large semi trucks, planes, and other vehicles. The “type” of the vehicle herein can also vary, and a single vehicle can correspond to many different types. For example, a 2012 Lexus RX350 could be categorized as a passenger vehicle, as a small SUV, as a Lexus, as a Lexus passenger vehicle, as a Lexus small SUV, etc. One of the significant advantages of the U-Me system is the ability to convert settings from a vehicle of one type to a vehicle of a different type. Thus, if a user normally drives a Ford F150 XLT pickup, the user's settings for his Ford pickup can be converted to corresponding settings in a Toyota rental car. Of course, brands or manufacturers are examples of “types” as well.

Home automation templates 1040 are shown in FIG. 18 to include a refrigerator template 1810, an HVAC template 1820, and an energy usage template 1830, which represent different things that may be controlled by a home automation system. Home automation templates 1040 may also include templates for specific home automation systems, such as Home Automation Inc. (HAI) Omni template 1840, Samsung refrigerator template 1850, lighting template 1860, as well as one or more other home automation templates 1870 that may be for a type of home automation controller or type of item controlled by a home automation controller or for a specific home automation controller or item controlled by a home automation controller.

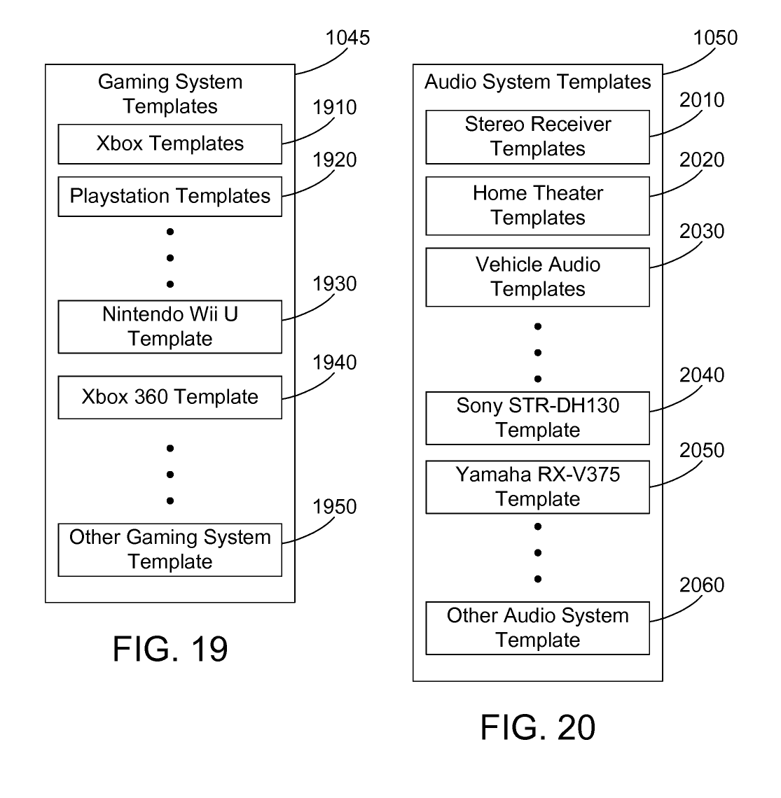

Gaming system templates 1045 are shown in FIG. 19 to include Xbox templates 1910 and Playstation templates, which represent different types of gaming systems. Gaming templates 1045 may also include templates for specific gaming systems, such as Nintendo Wii U template 1930 and Xbox 360 template 1940, as well as one or more other gaming system templates 1950 that may be for a type of gaming system or for a specific gaming system.

Audio system templates 1050 are shown in FIG. 20 to include stereo receiver templates 2010, home theater templates 2020, and vehicle audio templates 2030, which represent different types of audio systems. Audio system templates 1050 may also include templates for specific audio systems, such as Sony STR-DH130 template 2040 and Yamaha RX-V375 template 2050, as well as one or more other audio system templates 2060 that may be for a type of audio system or for a specific audio system.

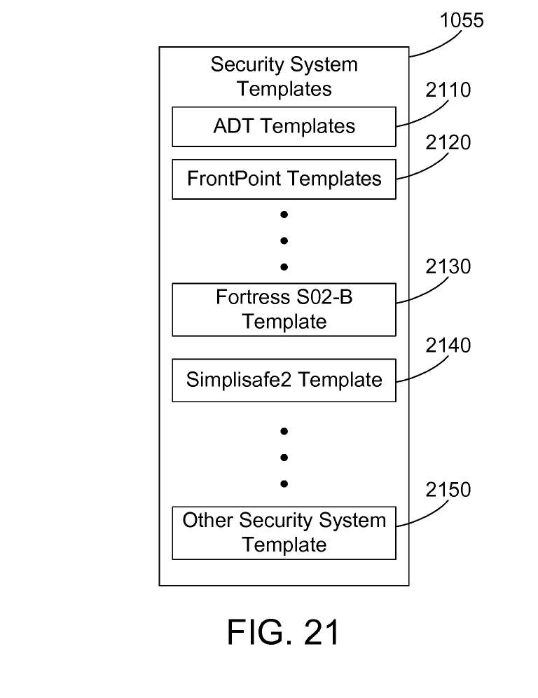

Security system templates 1055 are shown in FIG. 21 to include ADT templates 2110 and FrontPoint templates 2120, which represent different types of security systems from different manufacturers. Security system templates 1055 may also include templates for specific security systems, such as a Fortress SO2-B template 2130 and a Simplisafe2 template 2140, as well as one or more other security system templates 2150 that may be for a type of security system or for a specific audio system.

While the templates disclosed herein may be of any suitable format, it is expected that industry experts will have to spend time brainstorming and meeting to arrive at an industry standard. Thus, the automotive industry may generate an industry-standard template for cars, while the personal computer industry may generate a very different industry-standard template for desktop computers. Generating and publishing standard templates will greatly accelerate the acceptance of the U-Me system.

The device-specific templates shown in FIGS. 10-21 could be provided by any suitable entity. For example, the U-Me system may provide some of the device-specific templates. However, some device-specific templates will preferably be provided by manufacturers of devices. As discussed below, the U-Me system includes the capability of device manufacturers to become “U-Me Certified”, which means their devices have been designed and certified to appropriately interact with the U-Me system. Part of the U-Me certification process for a device manufacturer could be for the manufacturer to provide a universal template for each category of devices the manufacturer produces, a device-specific template for each category of devices the manufacturer produces, as well as a device-specific template for each specific device the manufacturer sells.

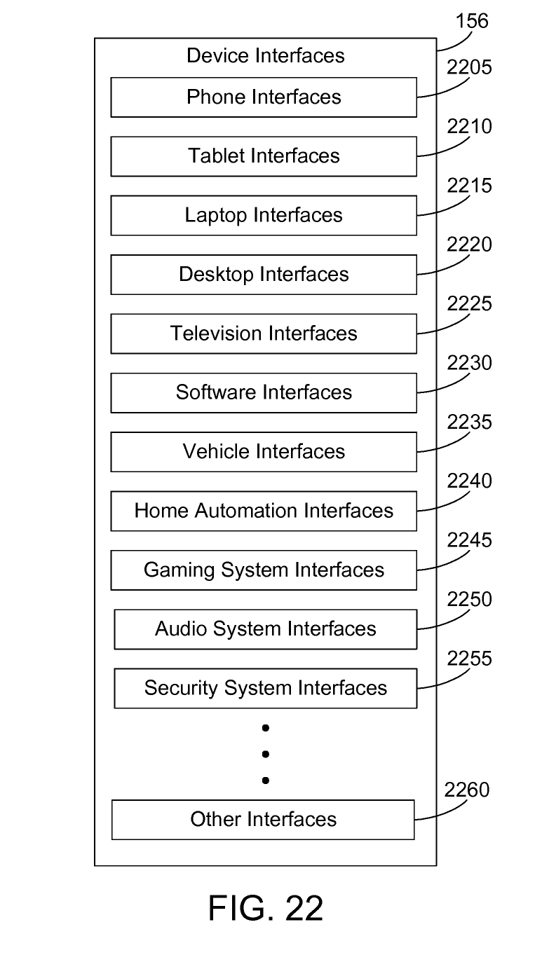

Referring to FIG. 22, device interfaces 156 preferably include phone interfaces 2205, tablet interfaces 2210, laptop interfaces 2215, desktop interfaces 2220, television interfaces 2225, software interfaces 2230, vehicle interfaces 2235, home automation interfaces 2240, gaming system interfaces 2245, audio system interfaces 2250, security system interfaces 2255, and other interfaces 2260. The device interfaces shown in FIG. 22 are examples shown for the purpose of illustration. The disclosure and claims herein extend to any suitable device interfaces, including device interfaces for devices known today as well as device interfaces for devices developed in the future.

Each device interface provides the logic and intelligence to interact with a specific type of device or with a specific device. Thus, phone interfaces 2205 could include an iPhone interface and an Android interface. In addition, phone interfaces 2205 could include different interfaces for the same type of device. Thus, phone interfaces 2205 could include separate phone interfaces for an iPhone 4 and an iPhone 5. In the alternative, phone interfaces 2205 could be combined into a single phone interface that has the logic and intelligence to communicate with any phone. In the most preferred implementation, a device interface is provided for each specific device that will interact with the U-Me system. This could be a requirement for a device to become U-Me certified, that the manufacturer of the device provide the device interface that meets U-Me specifications.

The U-Me system preferably includes a universal user interface 142 shown in FIG. 5. The universal user interface 2300 shown in FIG. 23 is one suitable example of a specific implementation for the universal user interface 142 shown in FIG. 5. The universal user interface 2300 in FIG. 23 includes several icons the user may select to access various features in the U-Me system. The icons shown in FIG. 23 include a data icon 2310, a licensed content icon 2320, a software icon 2330, a settings icon 2340, a devices icon 2350, and a templates icon 2360. Selecting the data icon 2310 gives the user access to the user data 120 stored in the user's U-Me account, including the types of data shown in FIG. 6. One way for the user to access the user data 120 is via a data search engine, discussed in more detail below. Selecting the licensed content icon 2320 gives the user access to any and all of the user's licensed content 130, including the categories of licensed content shown in FIG. 7. Selecting the software icon 2330 gives the user access to software available in the user's U-Me account. While software is technically a category of licensed content (see 735 in FIG. 7), a separate icon 2330 is provided in the universal user interface 2300 in FIG. 23 because most users would not mentally know to select the licensed content icon 2320 to run software. Selecting the software icon 2330 results in a display of the various software applications available in the user's U-Me account. The user may then select one of the software applications to run. The display of software icons could be considered a “virtual desktop” that is available anywhere via a browser or other suitable interface.

Selecting the settings icon 2340 gives the user access to any and all of the user settings 140, including the categories of settings shown in FIG. 8. Selecting the devices icon 2350 gives the user access to virtual devices, which are discussed in more detail below, where the virtual devices correspond to a physical device used by the user. The user will also have access to the device interfaces 156, including the device interfaces shown in FIG. 22. Accessing devices via the device interfaces allows the user to have remote control via the universal user interface over different physical devices. Selecting the templates icon 2360 gives the user access to the templates in the user's U-Me account, including: universal templates, including the universal templates shown in FIG. 9; and device-specific templates, including the device-specific templates shown in FIGS. 10-21. The devices icon 2350 and the templates icon 2360 provide access to information in the user's U-Me account pertaining to devices and templates, which can be part of the settings in the user's U-Me account. While the Devices icon 2350 and Templates icon 2360 could be displayed as a result of a user selecting the Setting icon 2240, these icons 2350 and 2360 that are separate from the settings icon 2340 are provided in FIG. 23 to make using the universal user interface 2300 more intuitive for the user.

The universal user interface gives the user great flexibility in accessing a user's U-Me account. In the most preferred implementation, the universal user interface is browser-based, which means it can be accessed on any device that has a web browser. Of course, other configurations for the universal user interface are also possible, and are within the scope of the disclosure and claims herein. For example, a user on vacation in a foreign country can go into an Internet café, invoke the login page for the U-Me system, log in, and select an icon that causes the universal user interface (e.g., 2300 in FIG. 23) to be displayed. The user then has access to any and all information stored in the user's U-Me account.

Because the universal user interface allows a user to access the user's U-Me account on any device, the universal user interface also provides a way for a user to change settings on the user's devices. Because the user's U-Me account includes virtual devices that mirror the configuration of their physical device counterparts, the user could use a laptop or desktop computer to define the settings for the user's phone. This can be a significant advantage, particularly for those who don't see well or who are not dexterous enough to use the tiny keypads on a phone. A simple example will illustrate. Let's assume a U-Me user wants to assign a specific ringtone to her husband's contact info in her phone. The user could sit down at a desktop computer, access the universal user interface 2300, select the Devices icon 2350, select a Phone icon, which then gives the user access to all of the settings in the phone. The user can then navigate a menu displayed on a desktop computer system using a mouse and full-sized keyboard to change settings on the phone instead of touching tiny links and typing on a tiny keyboard provided by the phone. The user could assign the ringtone to her husband's contact info in the settings in the virtual device in the U-Me account that corresponds to her phone. Once she makes the change in the virtual phone settings in the U-Me account, this change will be automatically propagated to her phone. The universal user interface may thus provide access to the user to set or change the settings for all of the user's physical devices.

The universal user interface 142 can include any suitable interface type. In fact, the universal user interface 142 can provide different levels of interfaces depending on preferences set by the user. Thus, the universal user interface may provide simple, intermediate, and power interfaces that vary in how the information is presented to the user depending on the user's preferences, which could reflect the technical prowess and capability of the user. Those who are the least comfortable with technology could select a simple interface, which could provide wizards and lots of help context to help a user accomplish a desired task. Those more comfortable with technology could select the intermediate interface, which provides fewer wizards and less help, but allows a user to more directly interact with and control the U-Me system. And those who are very technically-oriented can select the power interface, which provides few wizards or help, but allows the user to directly interact with and control many aspects of the U-Me system in a powerful way.

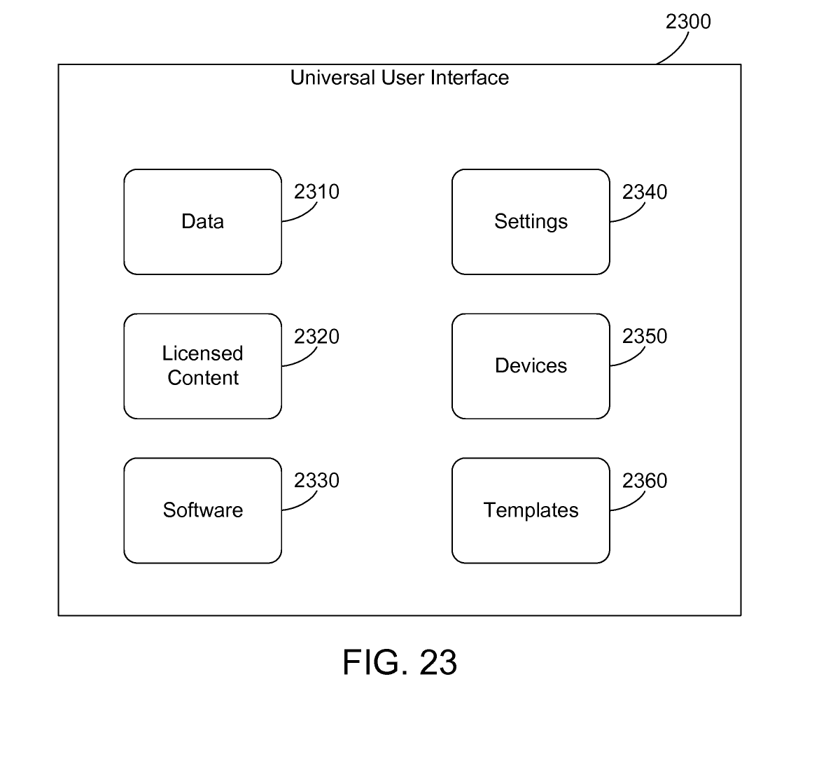

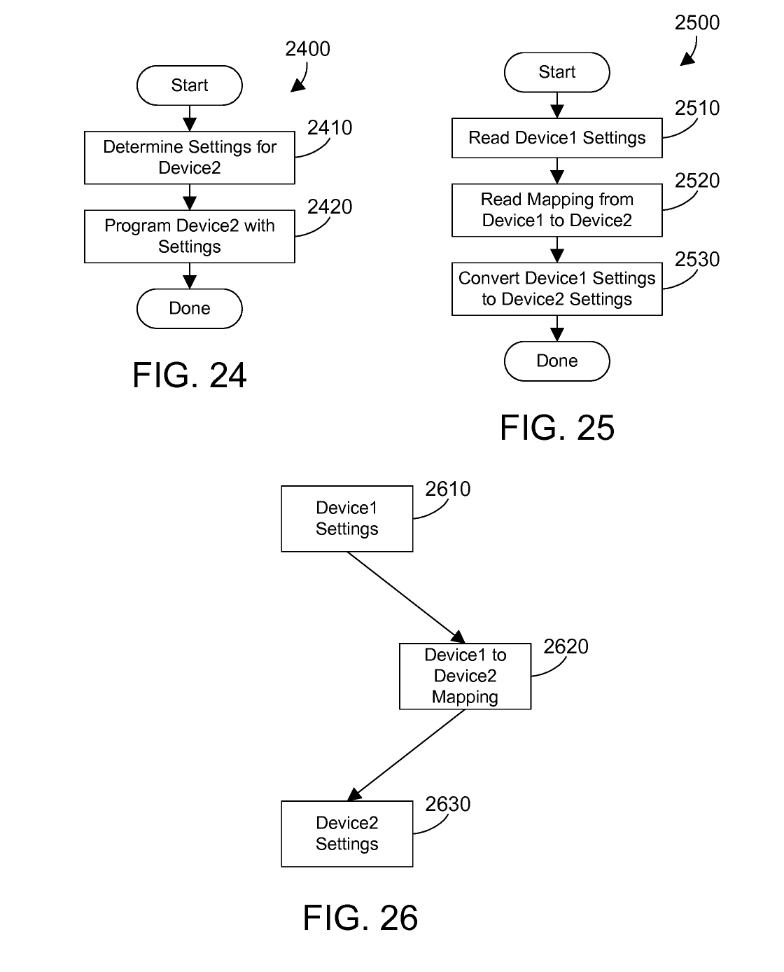

There are many different ways to program a device using the information in the user's U-Me account. Referring to FIG. 24, a method 2400 for programming a device called Device2 begins by determining settings for Device2 (step 2410), then programming the device with those settings (step 2420). There are different ways to determine the settings for Device2 in step 2410. Referring to FIG. 25, method 2500 shows one suitable implementation for step 2410 in FIG. 24. Settings for a device called Device1 are read (step 2510). A mapping from Device1 to Device2 is then read (step 2520). The settings for Device1 are then converted to the settings for Device2 (step 2530). This is shown graphically in FIG. 26, where the Device1 settings 2610 are converted using the Device1 to Device2 mapping 2620 to Device2 settings 2630. This first example in FIGS. 25 and 26 show how to program a device by converting settings from one device to settings for a different device. For example, let's assume a user has been using an iPhone 4, then decides to change to a Samsung Galaxy S4 phone. Assuming there are device-specific templates 154 for both phones, the conversion mechanism 160 in FIG. 5 can convert the settings on the iPhone 4 to settings on the Samsung Galaxy S4, provided there is a mapping in the phone templates between the device-specific settings of the two devices. The example in FIGS. 25 and 26 shows how to program a device by converting from settings of a different device.

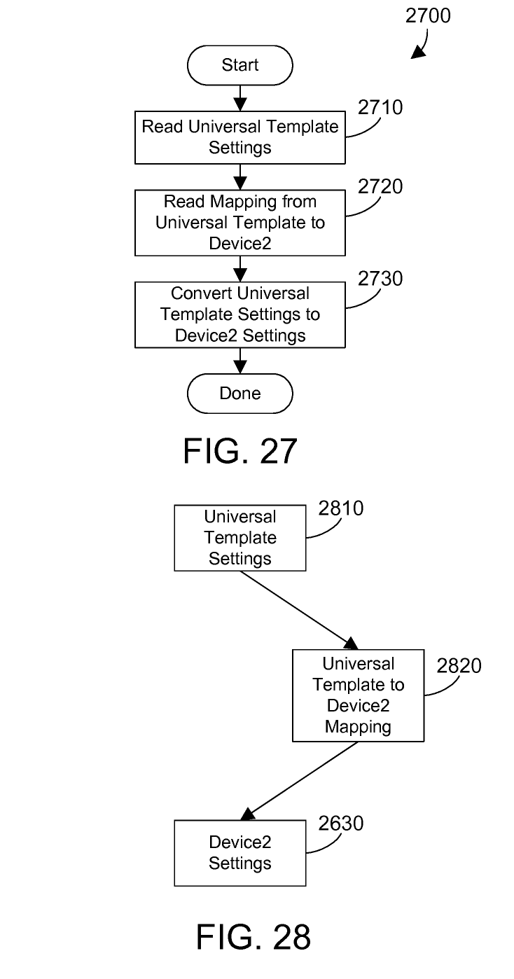

A second suitable implementation for step 2410 in FIG. 24 is shown in FIGS. 27 and 28. In this implementation, Device2 is programmed from settings stored in the Universal Template corresponding to Device2. The universal template settings are read (step 2710). A mapping from the universal template to Device 2 is read (step 2720). The conversion mechanism then converts the settings from the universal template to the settings for Device2 (step 2730). This is shown graphically in FIG. 28, where universal template settings 2810 are converted using the universal template to Device2 mapping 2820 to generate Device2 settings 2630. This second implementation in FIGS. 27 and 28 vary from the first implementation in steps 25 and 26 because the conversion of settings is between the universal template settings to the Device2 settings, not from the settings of another device (such as Device1).

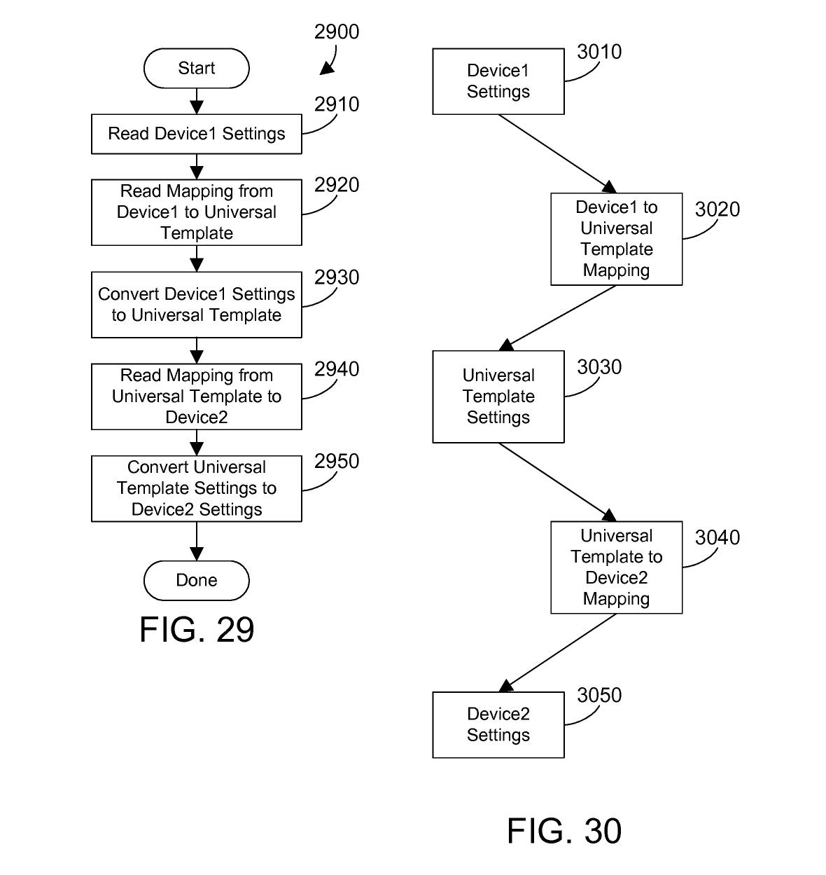

A third suitable implementation for step 2410 in FIG. 24 is shown in FIGS. 29 and 30. Device1 settings are read (step 2910). A mapping from Device1 to the universal template is also read (step 2920). The Device1 settings are then converted to the universal template settings (step 2930). A mapping from the universal template to Device2 is then read (step 2940). The universal template settings are then converted to Device 2 settings (step 2950). This is shown graphically in FIG. 30, where the Device1 settings are converted using the Device1 to universal template mapping 3020 to universal template settings 3030, which are then converted using the universal template to Device2 mapping 3040 to Device2 settings 3050. This third implementation converts settings between two devices, similar to the first implementation shown in FIGS. 25 and 26, but this is not a direct mapping between two devices, but is rather a mapping to and from universal template settings.

Note the examples in FIGS. 25-30 allow converting settings from one device to corresponding settings for a different device. The different device may be of the same type or may be of a different type. Type can be defined according to hardware platform, operating system, manufacturer, brand, or any other characteristic that characterizes a device. Thus, an iPhone and a Samsung Galaxy phone are devices of different types because they run different operating systems. A Chevrolet and a Toyota are devices of different types because they are made by different manufacturers. An iPhone 4 and iPhone5 could be categorizes as devices of the same type because they run the same operating system. The disclosure and claims herein extends to any suitable definition or categorization for the “type” of a device. The conversion mechanism disclosed and claimed herein allows converting settings between devices of the same type, between devices of similar type, and also between devices of different types.

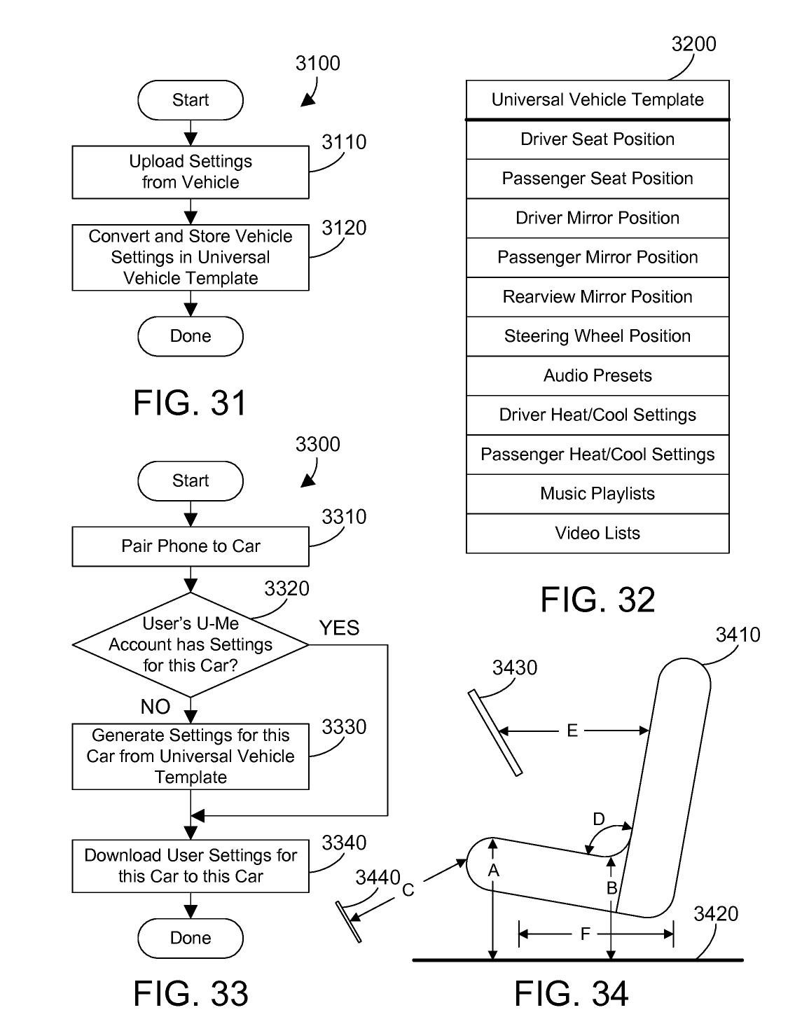

The U-Me system can be used to store vehicle settings for a user and to download those settings to a different vehicle, even a vehicle the user has never driven before. Let's assume a user travels from Kansas City to Chicago via airplane for a business meeting. Upon arriving in Chicago, the user rents a rental car. Let's assume the rental car is U-Me certified. The user can identify the rental car to the U-Me system, which can then determine the type of car, convert any of the user's settings as required for that car, and download the settings to the car. The user thus benefits from having the U-Me system configure the rental car according to his or her settings stored in the user's U-Me account. The various functions with respect to FIGS. 31-42 discussed below are preferably performed by the vehicle mechanism 180 in FIG. 5.

Referring to FIG. 31, method 3100 begins by uploading settings from a vehicle (step 3110). The vehicle settings may then be converted and stored in a universal vehicle template (step 3120). The vehicle settings could also be stored in a device-specific template for the user's vehicle. The conversion of settings in step 3120 may be performed by the conversion mechanism 160 shown in FIG. 5. One suitable universal vehicle template is shown at 3200 in FIG. 32, which is an example of a suitable universal vehicle template 940. The universal vehicle template 3200 includes settings for driver seat position, passenger seat position, driver mirror position, passenger mirror position, rearview mirror position, steering wheel position, audio presets, driver heat/cool settings, passenger heat/cool settings, music playlists, and video playlists.

The term “audio presets” in FIG. 32 can include presents for a satellite radio receiver, and can additionally include presents on the receiver or other audio mechanism in the vehicle that corresponds to a user's favorite songs. A simple example will illustrate. Let's assume a vehicle audio system allows a user to define three sets of six presets each for satellite radio stations. Let's further assume the vehicle audio system also allows a user to define three additional sets of presets that correspond to the user's favorite songs, which can be made available to the vehicle either by downloading or by streaming. If a user wants to listen to the '80s satellite radio station, the user can select a preset that is programmed for that station. If the user wants to listen to one of her favorite songs that she has purchased, she can select a preset that corresponds to the desired song.

The driver heat/cool settings can include heat and cool settings for the heating and air conditioning system for the driver's side of the car, and can additionally include heat/cool settings for the driver's seat. In addition, the heat/cool settings can be programmed as a function of temperature exterior to the car and temperature interior to the car. Thus, the user can define several different sets of desired heat/cool settings based on the outside temperature and/or based on the interior temperature of the car. A simple example for heating and cooling the driver's seat follows. Let's assume the user specifies that when the inside temperature of the car is less than 30 degrees Fahrenheit (−1 degrees Celsius), the seat heater is set to high. When the inside temperature is between 30 and 40 degrees Fahrenheit (between −1 and 4 degrees Celsius), the seat heater is set to medium. When the inside temperature is between 40 and 50 degrees (between 4 and 10 degrees Celsius), the seat heater is set to low. When the inside temperature is between 50 and 80 degrees Fahrenheit (between 10 and 27 degrees Celsius), the seat is neither heated nor cooled. When the inside temperature is between 80 and 90 degrees (between 27 and 32 degrees Celsius), the seat cooler is set to low. When the inside temperature is between 90 and 100 degrees (between 32 and 38 degrees Celsius), the seat cooler is set to medium. When the inside temperature is over 100 degrees (over 38 degrees Celsius), the seat cooler is set to high. This simple example shows how the climate control system can vary according to the environmental conditions inside the vehicle. Of course, the outside temperature could also be taken into account. Thus, even when the interior of the car is comfortable on a very cold day, a person will feel colder because of the cold glass that is in proximity to the person's head. Taking interior and/or exterior temperature into account can thus allow a user to define desired heat/cool settings that can be fine-tuned to the user's liking. While the examples above discuss heat/cool settings for the driver's seat, similar settings could be defined for the passenger's seat.

The universal vehicle template is preferably defined such that settings from different car manufacturers can all be converted to and from the settings in the universal vehicle template. We take the example of seat position to illustrate. Referring to FIG. 34, the position of seat 3410 can be expressed in numerous different ways. For example, the position of seat 3410 can be expressed in terms of the height A of the front of the seat above some reference point, such as the floor of the vehicle; height B of the rear of the seat above some reference point; distance C from the accelerator pedal 3440 to a front of the seat; angle D of the back portion with respect to the bottom portion; distance E from the center of the steering wheel to the seat back; and distance F from a reference point on the seat (such as the back) to some fixed reference point.

The way a car represents seat position may vary with the car manufacturer. For example, let's assume one car manufacturer allows adjusting the forward/backward position of the driver's seat over a ten inch span, and uses a stepper motor to do the adjusting. The position of the seat could be expressed as a numerical value for the stepper motor. A different manufacturer may allow adjusting the forward/backward position of the driver's seat over a twelve inch span using an analog motor and a position sensor, where the seat position is stored as a value of the position sensor. The universal vehicle template 3200 preferably describes seat position in a way that is actually descriptive of the position of the seat itself with respect to one or more physical features in the vehicle, not based on some motor settings or sensor readings of any particular manufacturer. This may require converting a vehicle's settings to a more universal measure of seat position, such as distance and angle, as represented in FIG. 34. In the most preferred implementation, the process of a car vendor becoming U-Me certified includes the car vendor providing a device-specific template for the car that includes mapping information for converting the car vendor's settings to the types of settings referenced in the universal vehicle template. In this scenario, the device-specific template will be used to do the conversion in step 3120 in FIG. 31 from the vehicle settings to the equivalent settings in the universal vehicle template.

Let's assume the user drives a 2012 Lexus RX350. When the user's settings in the 2012 Lexus RX350 are uploaded to the user's U-Me account, there may be multiple device-specific vehicle templates that apply to this vehicle, such as: a vehicle template for the 2012 Lexus RX350; a vehicle template for 2012 Lexus vehicles; a vehicle template for Lexus small SUVs; etc. These vehicle templates are preferably provided by the vehicle manufacturer to identify user settings in their vehicles, and how these settings map to the universal vehicle template.

FIG. 33 shows a method 3300 that could be representative, for example, of the steps when a user rents a car that is U-Me certified. First, the phone is paired to the car (step 3310). Pairing the phone to the car allows the user's phone to send the information identifying the car to the U-Me system, and to authenticate the user to the U-Me system via the user's phone. When the user's U-Me account already has settings for this car (step 3320=YES), the user settings for this car are downloaded from the user's U-Me account to the car (step 3340). This can happen, for example, when the user rents a car that is the same type of car the user drives at home, or is the same type of U-Me certified car the user has rented before. When the user's U-Me account does not have settings for this car (step 3320=NO), the settings for this car are generated from the universal vehicle template (step 3330), and those settings are then downloaded to the car (step 3340). As a result, all of the user's preferred settings (see FIG. 32) are made available in the rental car. The result is a car that is configured to the user's taste with minimal effort from the user. While the discussion above assumes the car communicates with the user's phone, which in turn communicates with the U-Me system, other configurations are possible. For example, a car or other vehicle could include a transceiver that allows the vehicle to directly interact with the U-Me system, instead of going through the user's phone.

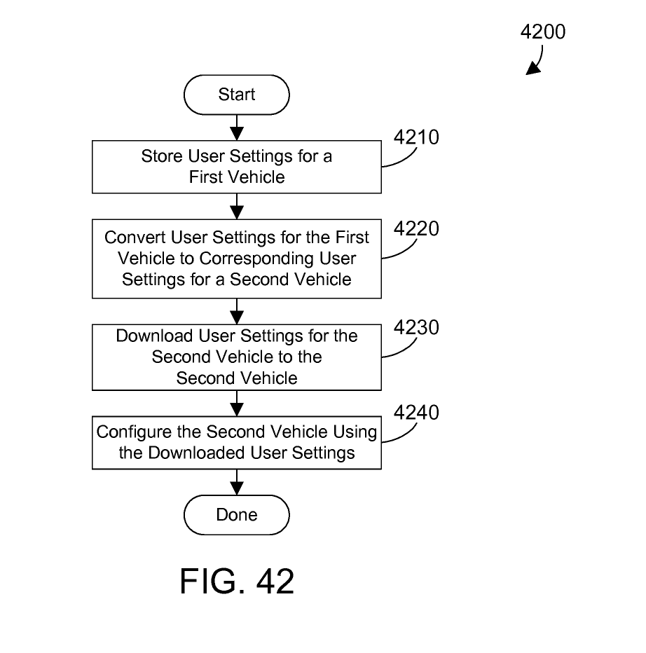

Referring to FIG. 42, a method 4200 is shown for converting user settings from a first vehicle to a second vehicle and for configuring the second vehicle using those settings. The user settings for the first vehicle are stored (step 4210). The user settings for the first vehicle are then converted to corresponding user settings for a second vehicle (step 4220). Note the second vehicle could be the same type as the first vehicle, could be a similar type as the first vehicle, or could be a different type as the first vehicle. The user settings for the second vehicle are then downloaded to the second vehicle (step 4230). The second vehicle is then configured using the downloaded user settings (step 4240). Method 4200 allows a user to rent a rental car of a type the user has never before driven, and have the rental car automatically configured according to the user's settings on a different car.

As stated above, the “type” of vehicle can vary. A simple example will illustrate. A second vehicle could be considered the “same type” as the first vehicle when the first and second vehicles have the exact same set of settings. This could happen, for example, when the two vehicles are the same vehicle just one model year apart. Note that “same set of settings” means all of the corresponding settings are expressed in the same units or in the same manner. Thus, a setting for horizontal driver seat position measured in distance from the floor is the same setting as a setting in a different vehicle for that also specifies horizontal driver seat position measured in distance from the floor. A setting for horizontal seat position measured in distance from the ceiling is a different setting than a setting for horizontal seat position measured in distance from the floor. Thus, if a first vehicle has settings of the same type as a second vehicle, the settings of the first vehicle can be used directly in the second vehicle.

A second vehicle could be considered a “similar type” as the first vehicle when the first and second vehicles share most of the same settings, but there are differences as well. This could happen, for example, between different models from the same manufacturer. A second vehicle could be considered a “different type” as the first vehicle when the first and second vehicles do not share most of the same settings. This could happen, for example, between different models from different manufacturers. The disclosure and claims herein expressly extend to any suitable way to define type of a vehicle, and the principles herein apply regardless of whether the settings are being converted between vehicles of the same type, between vehicles of a similar type, or between vehicles of different types.

Note the process for converting settings from the first vehicle to corresponding settings for the second vehicle varies according to whether the vehicles are of the same type, of a similar type, or of a different type. For vehicles of the same type (e.g., same make and model, different model year), the conversion in step 4220 may produce user settings for the second vehicle that are identical to the user settings for the first vehicle. In this case, conversion means simply using the same settings for the second vehicle as used for the first vehicle. For vehicles of a similar type or of a different type, the conversion in step 4220 may produce user settings for the second vehicle, some of which may be the same as settings for the first vehicle, and some or all of which may be different than the user settings for the first vehicle.

FIG. 3, FIGS. 25-34 and FIG. 42 support a computer system comprising: at least one processor; a memory coupled to the at least one processor; first user settings corresponding to a user for a first vehicle; a conversion mechanism executed by the at least one processor, the conversion mechanism converting the first user settings for the first vehicle to corresponding second user settings for the user for a second vehicle; and a software mechanism executed by the at least one processor that downloads the second user settings to the second vehicle.

FIGS. 25-34 and 42 support a computer-implemented method executing on at least one processor comprising: storing first user settings corresponding to a user for a first vehicle; converting the first user settings for the first vehicle to corresponding second user settings for the user for a second vehicle; and downloading the second user settings to the second vehicle.

FIGS. 25-34 and 42 support a computer-implemented method executing on at least one processor comprising: storing first user settings corresponding to a user for a first vehicle, wherein the first user settings comprise: seat position for at least one seat; mirror position for at least one mirror; at least one climate control setting; audio presets; and music licensed to the user; converting the first user settings for the first vehicle to corresponding second user settings for the user for a second vehicle; downloading the second user settings to the second vehicle; and configuring the second vehicle using the second user settings.

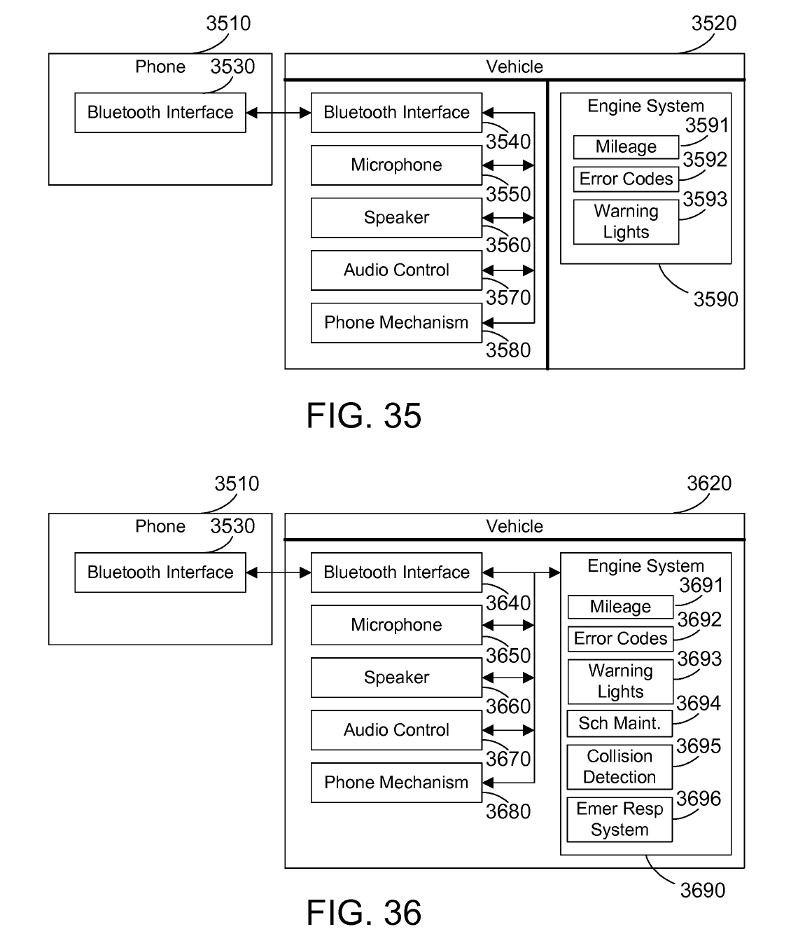

FIG. 35 shows a block diagram of a phone 3510 coupled via Bluetooth interfaces 3530 and 3540 to a prior art vehicle 3520. The Bluetooth interface 3540 of known cars provides a way to pair the phone 3510 to the vehicle 3520 so the user may use the phone hands-free while driving. The Bluetooth interface 3540 thus communicates with a phone mechanism 3580, which controls the microphone 3550, speaker 3560 and controls of the audio system 3570 during a phone call. For example, when the user is listening to the radio and a call comes in, the phone mechanism 3580 mutes the radio using the audio control 3570, announces via speaker 3560 the user has an incoming call, and when the user presses a button to answer the call, the phone mechanism 3580 then communicates with the phone 3510 to service the call, including playing the call audio on the speaker 3560 and receiving the user's voice input to the call via microphone 3550.

In known vehicles, a user cannot access any of the engine system 3590 via the Bluetooth interface 3540 that communicated with the user's phone. The engine system 3590 includes information in electronic form that could be useful to the user, including mileage 3519, error codes 3592, and warning lights 3593. Because prior art vehicles do not allow the phone to communicate with the engine system 3590, the user cannot use information that is generated in the engine system 3590.

Referring to FIG. 36, the same phone 3510 with its Bluetooth interface 3530 communicates with the Bluetooth interface 3640 to service telephone calls using microphone 3650, speaker 3660, audio control 3670, and phone mechanism 3680, similar to what is done in the prior art system shown in FIG. 35. Note, however, the Bluetooth interface 3640 has access to the engine system 3690. This means information in the engine system 3690 can be communicated via the Bluetooth interface 3640 to the user's phone, and from there to the user's U-Me account. Information such as mileage 3691, error codes 3692, warning lights 3693, scheduled maintenance 3694, collision detection 3695, and emergency response system 3696 can be made available to the U-Me system by a vehicle such as vehicle 3620 that has been U-Me certified.

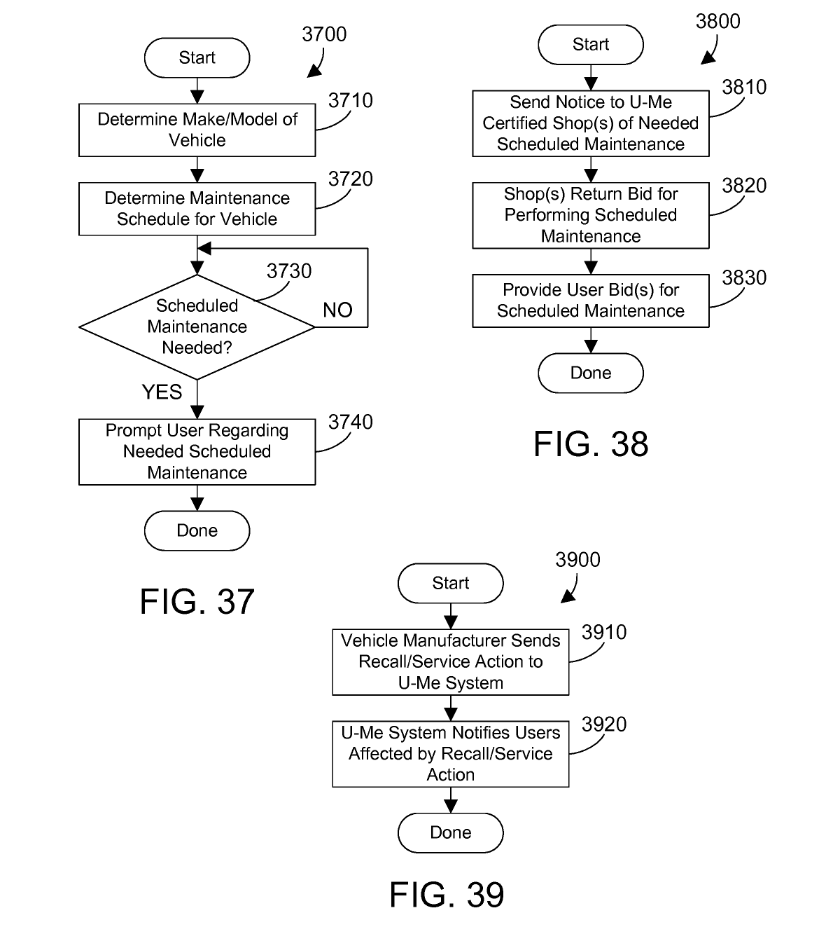

Method 3700 is shown in FIG. 37, and begins by determining the make and model of the vehicle (step 3710). The maintenance schedule for the vehicle is then determined (step 3720). When no scheduled maintenance is needed (step 3730=NO), method 3700 waits until scheduled maintenance is needed (step 3730=YES). The user is prompted regarding the needed scheduled maintenance (step 3740). Method 3700 is then done. Note the information in steps 3710 and 3720 may be stored in the engine system itself, as shown at 3694 in FIG. 36. In the alternative, the information in steps 3710 and 3720 may be retrieved from a manufacturer's website, from a third party website, or from the U-Me system. Because the U-Me system now has access to the engine system 3690 in FIG. 36 via the user's phone, the U-Me system can provide information regarding the status of the engine to the U-Me user.

When scheduled maintenance is needed (step 3730=YES in FIG. 37), the U-Me system can perform method 3800 in FIG. 38. A notice can be sent to one or more U-Me certified shops of the needed scheduled maintenance (step 3810). The notified shop(s) then return a bid for performing the scheduled maintenance to the U-Me system (step 3820). The U-Me system then provides the bids to the user (step 3830). In this manner the user can automatically receive bids from one shop or from competing shops with the bids for doing the scheduled maintenance. Note while FIG. 38 shows the specific case of scheduled maintenance, a similar method could be performed when an error code or engine warning light comes on so the user can automatically receive one or more bids for performing the repair that is needed based on the error code or warning light.

The U-Me system also provides a central place for vehicle manufacturers to notify customers of recalls or service actions, as shown in method 3900 in FIG. 39. Referring to FIG. 39, the vehicle manufacturer sends the recall or service action information to the U-Me system (step 3910). The U-Me system then notifies its users who are affected by the recall or service action (step 3920).

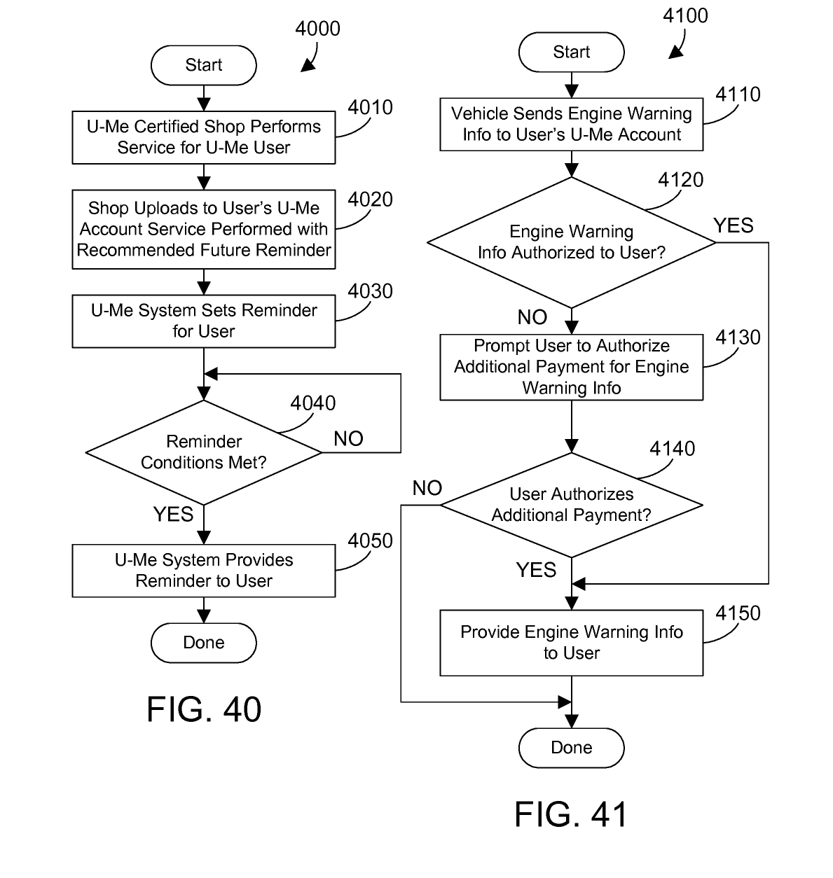

A great advantage to the U-Me system is having U-Me certified shops store the service performed on a user's vehicle to the user's U-Me account, which can trigger reminders for the user. Referring to FIG. 40, a method 4000 begins when a U-Me certified shop performs service for the U-Me user (step 4010). The shop uploads to the user's U-Me account the service performed by the shop, with a recommended future reminder (step 4020). For example, if the shop changes the oil, the shop could upload a record of the oil change along with a recommendation that a reminder be set to change the oil in 5,000 miles. The U-Me system sets the reminder for the user (step 4030). When the reminder conditions are not met (step 4040=NO), method 4000 waits, until the reminder conditions have been met (step 4040=YES). The U-Me system then provides a reminder to the user (step 4050). Method 4000 is especially useful for service that needs to be performed at specified mileage and/or time intervals, such as oil changes and rotation of the tires.

Once the user has access to the vehicle's engine system as shown in FIG. 36, other methods are possible, such as method 4100 shown in FIG. 41. The vehicle sends engine warning information to the user's U-Me account (step 4110). Engine warning information can include, for example, information from error codes 3692, warning lights 3693, a collision detection system 3695, or an emergency response system 3696. When the engine warning is authorized to the user (step 4120=YES), the engine warning information is provided to the user (step 4150). When the engine warning is not authorized to the user (step 4120=NO), the user may be prompted to authorize additional payment for access to the engine warning information (step 4130). When the user does not authorize the additional payment (step 4140=NO), method 4100 is done. When the user authorizes the additional payment (step 4140=YES), the engine warning information is provided to the user (step 4150). A simple example will illustrate. Let's assume the engine produces an error code that indicates the fuel pump is failing. This could be indicated on the dash by a “service engine soon” light, but this does not give the user any meaningful information regarding what service is required. Having access to this engine warning information could cost a premium above the normal U-Me subscription, so the user could be prompted in step 4130 to authorize an additional charge of, say $5, to access the information. If the user is on a long highway trip and the “service engine soon” light comes on, the user doesn't know whether the warning is minor or more serious. In the case of a fuel pump that is failing, knowing the fuel pump is failing may allow the user to stop at a repair shop in the next town. In this scenario, paying an extra $5 for the engine warning information is money well-spent.

While the implementation envisioned herein has the majority of storage for the user's information in the cloud, this cloud-based implementation may not be the ultimate end game. As technology advances, a handheld device like a smart phone could eventually have the capability of storing all of a user's information and could have sufficient computing capacity to perform all needed processing. Thus, the apparatus 300 shown in FIG. 3 could be representative of a handheld device, with the Universal Me system 100 running on the handheld device. In this scenario, when a user rents a rental car, the user could scan a machine-readable code or enter a code into the user's smart phone to identify the rental car. The Universal Me app running on the smart phone will determine the type of car corresponding to the code, and when the Universal Me app does not have settings for this type of car, the Universal Me app will convert the user's settings to corresponding settings for this rental car, and will download the settings to the car via the smart phone's local interface (e.g., Bluetooth). As shown by this simple example, when the storage and computing capacity of smart phones becomes sufficiently large, most of the processing in the Universal Me system could be performed on the smart phone. The cloud would continue to be used for backup and for virtual devices, but much of the user's information could be stored on the user's smart phone, which could then be used to perform the many functions discussed herein without accessing the user's U-Me account in the cloud.

As is clear from the detailed discussion above, the U-Me system provides a computer-implemented method executing on at least one processor comprising the steps of storing user data corresponding to a first user, wherein the user data corresponding to the first user comprises files, contacts, e-mail, calendar, tasks, reminders and digital photos; storing licensed content that is licensed to the first user, wherein the licensed content comprises music, movies, electronic books, software and games; storing first user settings corresponding to the first user for a plurality of software applications, wherein the first user settings comprise first user preferences for each of the plurality of software applications; storing second user settings corresponding to the first user for a plurality of physical devices, wherein the second user settings comprise second user preferences for each of the plurality of physical devices, wherein the plurality of physical devices comprises a mobile phone and a computer system; authenticating the first user on a first device used by first the user by scanning a fingerprint of the first user and comparing the scanned fingerprint against a previously-stored reference fingerprint for the first user; making the user data, the licensed content, the first user settings, and the second user settings available to the first user on a first device used by the first user; and converting user settings for a first physical device to user settings for a second physical device.

One of the long-term goals of the U-Me system is to create a place for all of a user's data, licensed content and settings. This includes settings for devices we have not yet dreamed of. The philosophy is very simple. If the user is going to spend time configuring any device to the user's liking by specifying settings for the device, let's store those settings in the user's U-Me account so those settings can be used to reconfigure an identical or similar device, or so those settings can be used to generate suitable settings for a different kind of device. Thus, if a person spends hours configuring a computerized sewing machine to perform certain functions by specifying many different settings for the sewing machine, let's store those settings to the user's U-Me account. This philosophy can extend to any and all devices known today and developed in the future.

It will take time for the U-Me system to be deployed and to gain acceptance in the marketplace. It will take even longer to get device manufacturers and licensed content providers on-board to the point they are providing devices and content that are U-Me certified. It may take even longer to realize the vision of having a user's data, licensed content, and settings available in cars, hotel rooms and resorts. The certification process is another possible revenue stream for the company providing the U-Me system. There will come a point when the U-Me system achieves critical mass, where the public demands compatibility with the U-Me system. At that point, even the most reluctant vendors will have to become U-Me certified to meet the demands of their customers.

The specification herein uses different terms for phones, including cell phones, smart phones, and just “phones.” These are all examples of different mobile phones. The disclosure and claims herein expressly extend to any and all mobile phones, whether currently known or developed in the future.

The specification herein discusses different types of computing devices, including smart phones, tablets, laptop computers, and desktop computers. The term “computer system” as used herein can extend to any or all of these devices, as well as other devices, whether currently known or developed in the future. In one specific context, a computer system is a laptop or desktop computer system, which is a different type than a phone or a tablet.

The disclosure herein uses some shortened terms for the sake of simplicity. For example, the word “information” is shortened in many instances to “info”, the word “photograph” is shortened in many instances to “photo”, the word “specifications” is shortened in some instances to “specs”, and the word “medications” is shortened in some instances to “meds.” Other shortened or colloquial terms may appear in the specification and drawings, which will be understood by those of ordinary skill in the art.

Many trademarks and service marks have been referenced in this patent application. Applicant has filed US federal service mark applications for “Universal Me” and for “U-Me”. All other trademarks and service marks herein are the property of their respective owners, and applicant claims no rights in these other marks.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A computer system comprising:
at least one processor;
a memory coupled to the at least one processor;
first user settings corresponding to a user for a first vehicle;
a conversion mechanism executed by the at least one processor, the conversion mechanism converting the first user settings for the first vehicle to corresponding second user settings for the user for a second vehicle; and
a software mechanism executed by the at least one processor that downloads the second user settings to the second vehicle.

2. The computer system of claim 1 wherein the first user settings for the first vehicle and the second user settings for the second vehicle comprise seat position for at least one seat.

3. The computer system of claim 1 wherein the first user settings for the first vehicle and the second user settings for the second vehicle comprise mirror position for at least one mirror.

4. The computer system of claim 1 wherein the first user settings for the first vehicle and the second user settings for the second vehicle comprise at least one climate control setting.

5. The computer system of claim 1 wherein the first user settings for the first vehicle and the second user settings for the second vehicle comprise audio presets.

6. The computer system of claim 1 the first user settings for the first vehicle and the second user settings for the second vehicle comprise music licensed to the user.

7. The computer system of claim 1 wherein the first user settings for the first vehicle and the second user settings for the second vehicle comprise video licensed to the user.

8. The computer system of claim 1 wherein the first vehicle and the second vehicle are of a similar type.

9. The computer system of claim 1 wherein the first vehicle and the second vehicle are of different types.

10. A computer-implemented method executing on at least one processor comprising:
storing first user settings corresponding to a user for a first vehicle;
converting the first user settings for the first vehicle to corresponding second user settings for the user for a second vehicle; and
downloading the second user settings to the second vehicle.

11. The method of claim 10 further comprising:
configuring the second vehicle using the second user settings.

12. The method of claim 10 wherein the first user settings for the first vehicle and the second user settings for the second vehicle comprise seat position for at least one seat.

13. The method of claim 10 wherein the first user settings for the first vehicle and the second user settings for the second vehicle comprise mirror position for at least one mirror.

14. The method of claim 10 wherein the first user settings for the first vehicle and the second user settings for the second vehicle comprise at least one climate control setting.

15. The method of claim 10 wherein the first user settings for the first vehicle and the second user settings for the second vehicle comprise audio presets.

16. The method of claim 10 the first user settings for the first vehicle and the second user settings for the second vehicle comprise music licensed to the user.

17. The method of claim 10 wherein the first user settings for the first vehicle and the second user settings for the second vehicle comprise video licensed to the user.

18. The method of claim 10 wherein the first vehicle and the second vehicle are of a similar type.

19. The method of claim 10 wherein the first vehicle and the second vehicle are of different types.

20. A computer-implemented method executing on at least one processor comprising:
storing first user settings corresponding to a user for a first vehicle, wherein the first user settings comprise:
seat position for at least one seat;
mirror position for at least one mirror;
at least one climate control setting;
audio presets; and
music licensed to the user;
converting the first user settings for the first vehicle to corresponding second user settings for the user for a second vehicle;
downloading the second user settings to the second vehicle; and
configuring the second vehicle using the second user settings.
